(19) United States
(12) Patent Application Publication
(10) Pub. No.: US 2018/0225263 A1
(43) Pub. Date: Aug. 9, 2018

(54) INLINE INSERTION VIEWPORT

(71) Applicant: Microsoft Technology Licensing, LLC, Redmond, WA (US)

(72) Inventors: Fan Zhong, Redmond, WA (US); Itai Almog, Redmond, WA (US)

(73) Assignee: Microsoft Technology Licensing, LLC, Redmond, WA (US)

(21) Appl. No.: 15/425,668

(22) Filed: Feb. 6, 2017

(51) Int. Cl. G06F 17/21; G06F 17/24; G06T 11/60; G06F 3/0481; G06F 3/0482; H04N 5/232; G06F 3/0484

(52) U.S. Cl. CPC G06F 17/212; G06F 17/24; G06T 11/60; G06F 3/0481; G06T 2200/24; H04N 5/23216; H04N 5/23293; G06F 3/04845; G06F 3/0482

(57) ABSTRACT

An inline insertion viewport is provided. Aspects provide a preview of a content element within the context of a content authoring canvas prior to insertion of the content element into the canvas. Responsive to a selection of a functionality associated with inserting a content element into a canvas from within a content authoring tool user interface, an insertion viewport is displayed at an insertion point in the canvas, wherein the viewport comprises a preview of the content element. In a particular example, the user is enabled to utilize a camera functionality via the content authoring tool, wherein a preview of an image seen through the lens of a built-in or communicatively attached camera is displayed in the viewport, enabling the user to see how the content element looks within the context of the canvas prior to committing to capture and insert the content element in the canvas.

### BACKGROUND

Computing device users have increasingly come to expect that interaction with their devices and with the content displayed on the devices will be natural, intuitive, and efficient. In particular, when using a content authoring tool, such as an electronic mail and contacts application, a messaging application, a word processing application, a spreadsheet application, a database application, a slide presentation application, a drawing or computer-aided application program, a notes-taking application, a mobile application, a web application, a browser application, or the like, it is commonplace to insert a content element into the content authoring canvas. For example, the user may wish to take and insert a photo, insert a previously-captured or stored photo, insert a clip art image, shape, chart, or the like into a page, sheet, slide, or message.

Currently, the user may have to switch to another functionality tool or access a menu or user interface outside of the current context for inserting a desired content element. As can be appreciated, stopping to jump to another screen, menu, or user interface can increase the complexity of the user interface and interrupt the user's content authoring session, which degrades the user's content authoring experience and lengthens the time it takes to create content to the user's specification.

### SUMMARY

This summary is provided to introduce a selection of concepts in a simplified form that are further described below in the Detailed Description section. This summary is not intended to identify key features or essential features of the claimed subject matter, nor is it intended as an aid in determining the scope of the claimed subject matter.

Aspects are directed to an automated system, method, and computer storage medium for providing improved usability of content authoring tools that enable a preview of an insertion of a content element within the context of a content authoring canvas (e.g., document, message, note) prior to insertion of the content element into the canvas. By employing aspects of the present disclosure, an improved user experience is provided, where the user is enabled to select and utilize a functionality associated with inserting a content element into a content authoring canvas from within a content authoring tool user interface. Aspects of the present disclosure provide an insertion viewport for displaying a preview of the content element at the insertion point in the content authoring canvas for providing an inline view of the content element within the context of the canvas prior to insertion of the content element into the canvas without requiring the user to switch authoring tools or access menus. Accordingly, the user is enabled to use a functionality associated with (optionally capturing and) inserting a content element into a content authoring canvas faster, more accurately, and more efficiently than before. Further, the insertion viewport can be dragged to another position in the canvas to re-anchor its position and to re-arrange the order between the insertion viewport and the context of the content authoring canvas. Accordingly, the layout of the canvas can be optimized prior to insertion of the content element. Additionally, because the user is not required to switch authoring tools, less system memory and fewer processing resources are expended to author content in the content authoring tool, and the functionality of the computing device used to provide the content authoring tool is thereby expanded and improved.

Examples are implemented as a computer process, a computing system, or as an article of manufacture such as a device, computer program product, or computer readable medium. According to an aspect, the computer program product is a computer storage medium readable by a computer system and encoding a computer program of instructions for executing a computer process.

The details of one or more aspects are set forth in the accompanying drawings and description below. Other features and advantages will be apparent from a reading of the following detailed description and a review of the associated drawings. It is to be understood that the following detailed description is explanatory only and is not restrictive of the claims.

### BRIEF DESCRIPTION OF THE DRAWINGS

The accompanying drawings, which are incorporated in and constitute a part of this disclosure, illustrate various aspects. In the drawings:

FIG. 1 is a block diagram of an example operating environment including a system for providing an inline insertion viewport;

FIGS. 2A-2F illustrate an example user interface (UI) storyboard generated by aspects of a content authoring tool showing a scenario where a user captures and inserts a photo in a message in a messaging application;

FIGS. 3A-3B illustrate an example UI storyboard generated by aspects of a content authoring tool showing a use case for capturing and inserting a photo in a content authoring canvas embodied as a page in a notes taking application;

FIGS. 4A-4D illustrate an example UI storyboard generated by aspects of a content authoring tool showing a use case for capturing and inserting a photo in a content authoring canvas embodied as a spreadsheet in a spreadsheet application;

FIGS. 5A-5D illustrate an example UI storyboard generated by aspects of a content authoring tool showing a use case for selecting and inserting a stored photo in a content authoring canvas embodied as an email message in an email application;

FIGS. 6A-6D illustrate an example UI storyboard generated by aspects of a content authoring tool showing a use case for capturing a photo in a content authoring canvas embodied as a document in a word processing application, and re-anchoring the insertion viewport prior to insertion of the photo;

FIG. 7 is a flow chart showing general stages involved in an example method for providing an inline insertion viewport;

FIG. 8 is a block diagram illustrating example physical components of a computing device;

FIGS. 9A and 9B are block diagrams of a mobile computing device; and

FIG. 10 is a block diagram of a distributed computing system.

### DETAILED DESCRIPTION

The following detailed description refers to the accompanying drawings. Wherever possible, the same reference numbers are used in the drawings and the following description refers to the same or similar elements. While examples may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description is not limiting, but instead, the proper scope is defined by the appended claims. Examples may take the form of a hardware implementation, or an entirely software implementation, or an implementation combining software and hardware aspects. The following detailed description is, therefore, not to be taken in a limiting sense.

Aspects of the present disclosure are directed to a method, system, and computer storage medium for providing an inline insertion viewport. While referred to herein as a viewport, it should be understood that this element may include any view window, display or other suitable view element associated with a content insertion functionality described herein for providing a preview of a content element or item that may be inserted inline as described herein. Improved usability of a content authoring tool is enabled by providing a preview of a content element within the context of a content authoring canvas prior to insertion of the content element into the canvas. Responsive to a selection of a functionality associated with inserting a content element into a canvas from within a content authoring tool user interface, an insertion viewport is displayed at an insertion point in the canvas, wherein the viewport comprises a preview of the content element. In a particular example, the user is enabled to utilize a camera functionality via the content authoring tool, wherein a preview of an image seen through the lens of a built-in or communicatively attached camera is displayed in the viewport, enabling the user to see how the content element looks within the context of the canvas prior to committing to capture and insert the content element in the canvas. In other examples, a preview of a stored photo, video, clip art image, shape, chart, or other content element is displayed in the viewport, enabling the user to see how the content element looks within the context of the canvas prior to committing to selecting and inserting the content element in the canvas.

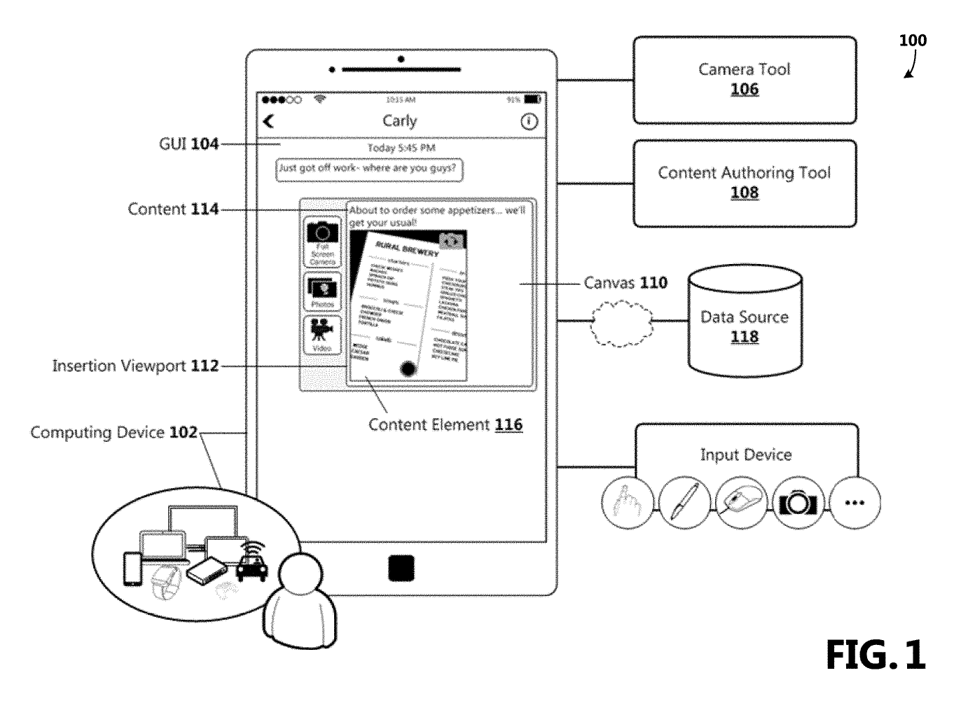

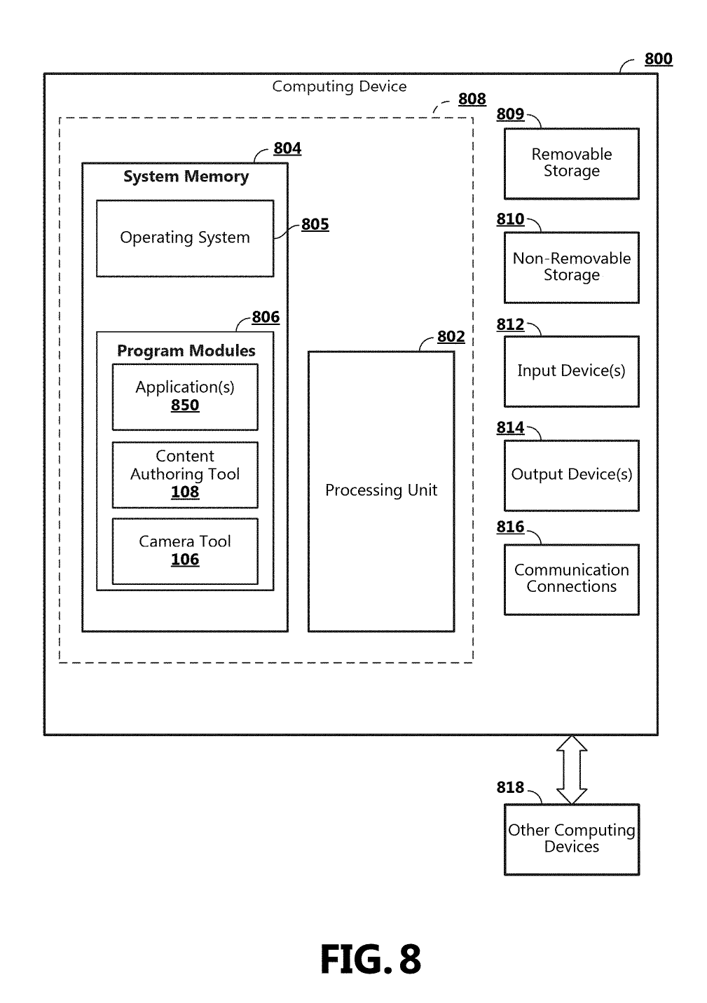

With reference now to FIG. 1, an example operating environment 100 including a system for providing an inline insertion viewport is shown. The example operating environment 100 includes a computing device 102 that is operable by a user. The computing device 102 may be one of various types of computing devices (e.g., a tablet computing device, a desktop computer, a mobile communication device, a laptop computer, a laptop/tablet hybrid computing device, a large screen multi-touch display, a gaming device, a smart television, a wearable device, a connected automobile, a smart home device, or other type of computing device). The hardware of these computing devices is discussed in greater detail in regard to FIGS. 8, 9A, 9B, and 10.

The computing device 102 includes a content authoring tool 108. A user may utilize the content authoring tool 108 for a variety of tasks, which may include, for example, to write, calculate, draw, organize, prepare and view presentations, send and receive electronic mail, take and organize notes, make music, and the like. The content authoring tool 108 may include thick client applications, which are stored locally on the computing device 102 or may include thin client applications (i.e., web applications) that reside on a remote server and accessible over a network or combination of networks (e.g., the Internet, wide area networks, local area networks). A thin client application may be hosted in a browser-controlled environment or coded in a browser-supported language and reliant on a common web browser to render the application executable on the computing device 102.

Examples of the content authoring tool 108 include applications such as electronic mail and contacts applications, messaging applications, word processing applications, spreadsheet applications, database applications, slide presentation applications, drawing or computer-aided application programs, notes-taking applications, mobile applications, browser applications, and the like. As should be appreciated, the content authoring tool 108 is not limited to the above examples. Other content authoring tools are possible and are within the scope of the present disclosure.

According to examples, a graphical user interface (GUI) 104 is provided for enabling the user to interact with functionalities of the content authoring tool 108 or provided via the content authoring tool 108 through manipulation of graphical icons, visual indicators, and the like. Content 114 displayed in the application GUI 104 may vary according the content authoring tool 108 used. In various examples, the GUI 104 includes a toolbar, comprising various tools and settings related to authoring the content 114 and a content region display area, in which a content authoring canvas 110 is displayed. According to an aspect, the content authoring tool 108 is operative to receive input from the user, such as text input, drawing input, inking input, selection input, etc., via various input methods, such as those relying on mice, keyboards, and remote controls, as well as Natural User Interface (NUI) methods, which enable a user to interact with a device in a “natural” manner, such as via speech recognition, touch and stylus recognition, gesture recognition both on screen and adjacent to the screen, air gestures, head and eye tracking, voice and speech, vision, touch, hover, gestures, and machine intelligence. According to an example, the user input results in content 114 being added to the content authoring canvas 110. Non-limiting examples of a content authoring canvas 110 include a page, a spreadsheet, a slide, an email, a message, etc.

According to aspects, the content authoring tool 108 is operative to enable utilization of a functionality for inserting a content element 116 into the content authoring canvas 110. In various examples, the functionality provides additional functions, such as camera functions. The functionality may be built into the content authoring tool 108, may be provided by the computing device's operating system, or may be provided by another application, for example, via an API (application programming interface). In the example shown in FIG. 1, the content authoring tool 108 (e.g., messaging application) receives a selection input from the user wherein the selection relates to utilizing a camera functionality from within the content authoring tool. According to an aspect, when the camera functionality is selected, the camera functionality is activated, and the content authoring tool 108 displays an insertion viewport 112 associated with the camera functionality at the insertion point in the content authoring canvas 110. That is, the insertion viewport 112 is displayed inline in the messaging application canvas 110 at the point where the next characters typed would appear on the screen. The insertion point is oftentimes represented by a blinking vertical line.

According to aspects, the insertion viewport 112 provides a preview of a content element 116 in the context of the canvas 110 and the canvas content 114 prior to insertion into the canvas 110. For example, when the camera functionality is selected, a preview of an image seen through the lens of a built-in or communicatively attached camera is displayed in the insertion viewport 112, enabling the user to see how the content element 116 (i.e., photo) looks within the context of the canvas 110 prior to committing to capture and insert the content element in the message. The user is enabled to utilize the camera functionality in the content authoring tool 108 to capture and insert the photo image in the content authoring canvas 110 with confidence. Among other benefits, the disclosed technology allows the user to continue working in the content authoring tool 108 throughout the photo capturing and insertion process so that the user's concentration is not broken by switching to a camera tool 106. According to an aspect, the camera tool 106 is operative to provide camera functionality integrated with or communicatively attached to the computing device 102. For example, by not jumping to a separate dedicated UI screen, such as a camera tool screen, user interaction efficiency is increased. Additionally, by allowing the user to see a preview of the end result of a selected functionality prior to capturing a photo or inserting the photo in the content authoring canvas 110, the user is enabled to capture a desired image with confidence. As can be appreciated, the disclosed technology reduces the likelihood of capturing an undesirable photo or inserting content that needs to be revised because it does not appear in the canvas 110 the way the user intended, thus conserving memory and reducing processor load.

Although the above example is described in the context of using camera functionality in a messaging application to capture and insert a photo in a message, aspects of the disclosed technology can be utilized in a variety of contexts. For example and as will be described in further detail below with respect to various example UI illustrations, an inline insertion viewport 112 can be utilized to provide a preview of other content element 116 types in the context of a variety of content authoring tool canvases 110 and the canvas content 114 before being inserted into the canvas 110. For example, an inline insertion viewport 112 is provided for enabling the user to view and select a stored photo, video, clip art image, shape, chart, or other content element 116 in the context of the content authoring canvas 110 at the insertion point prior to inserting the content element 116 into the canvas 110. In some examples, the content authoring tool 108 is in communication with one or more data sources 118 where content elements 116 are stored. The one or more data sources 118 may be local to the computing device 102, or may be accessed over a network.

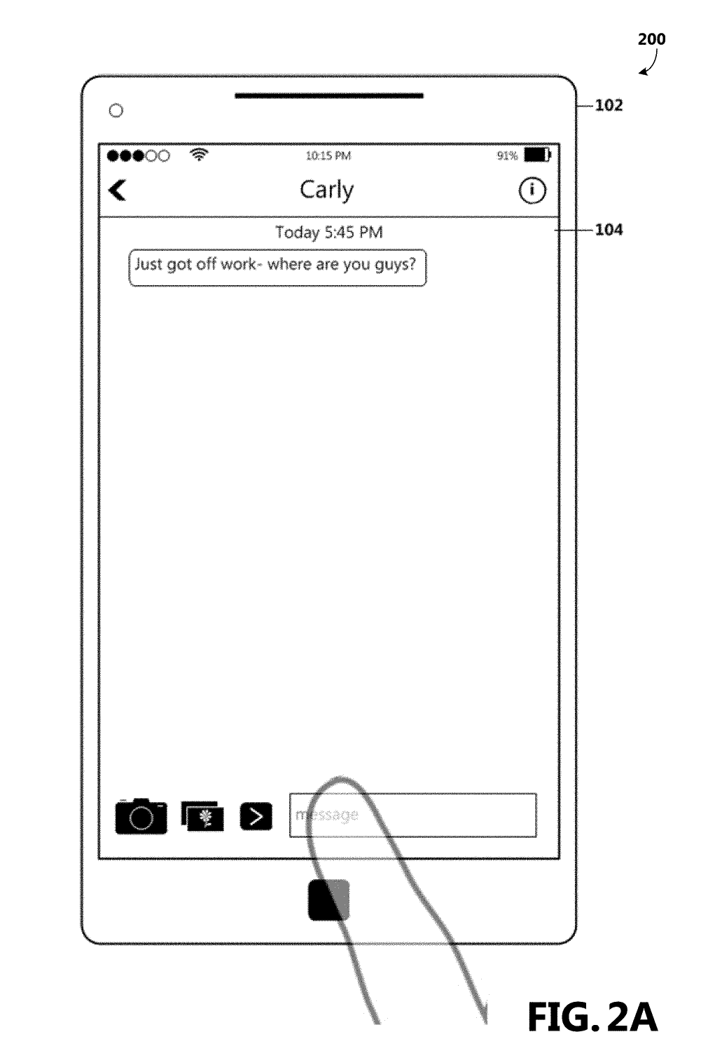

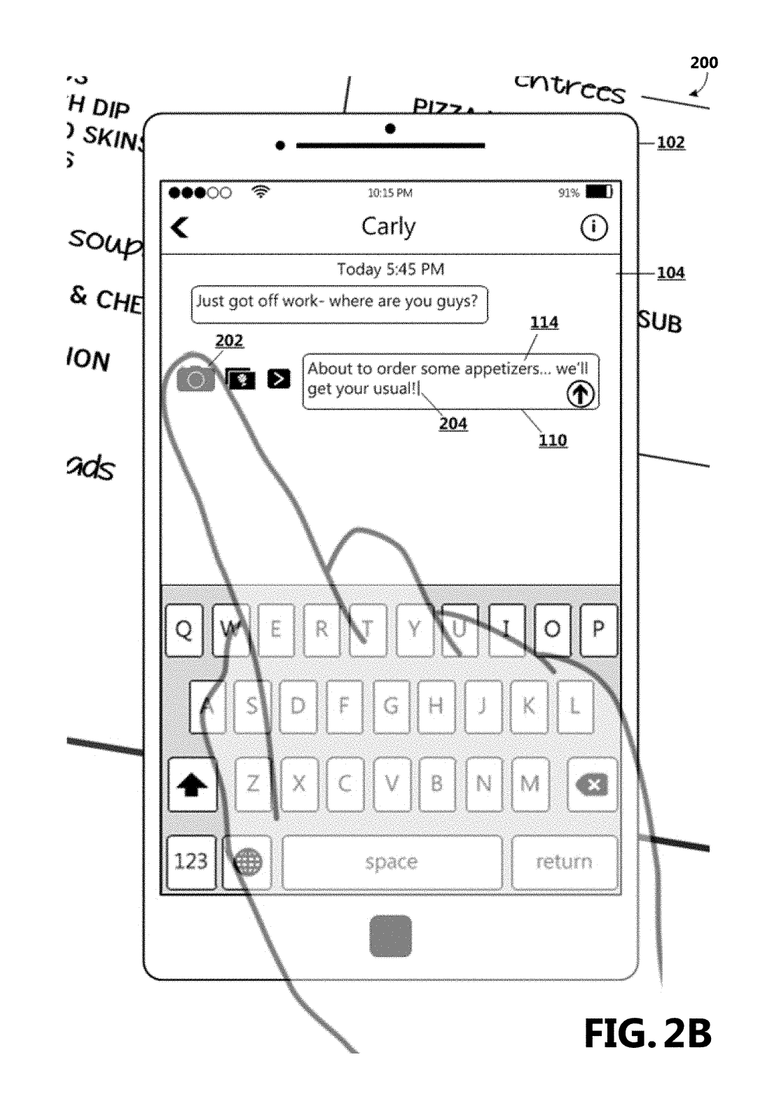

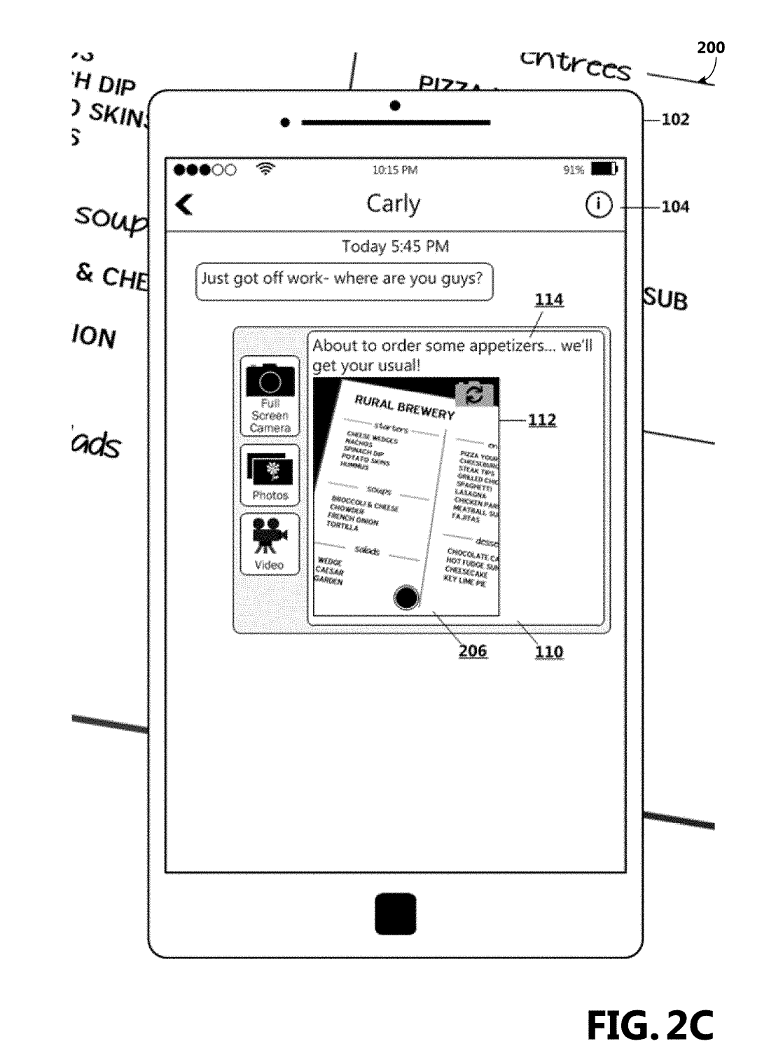

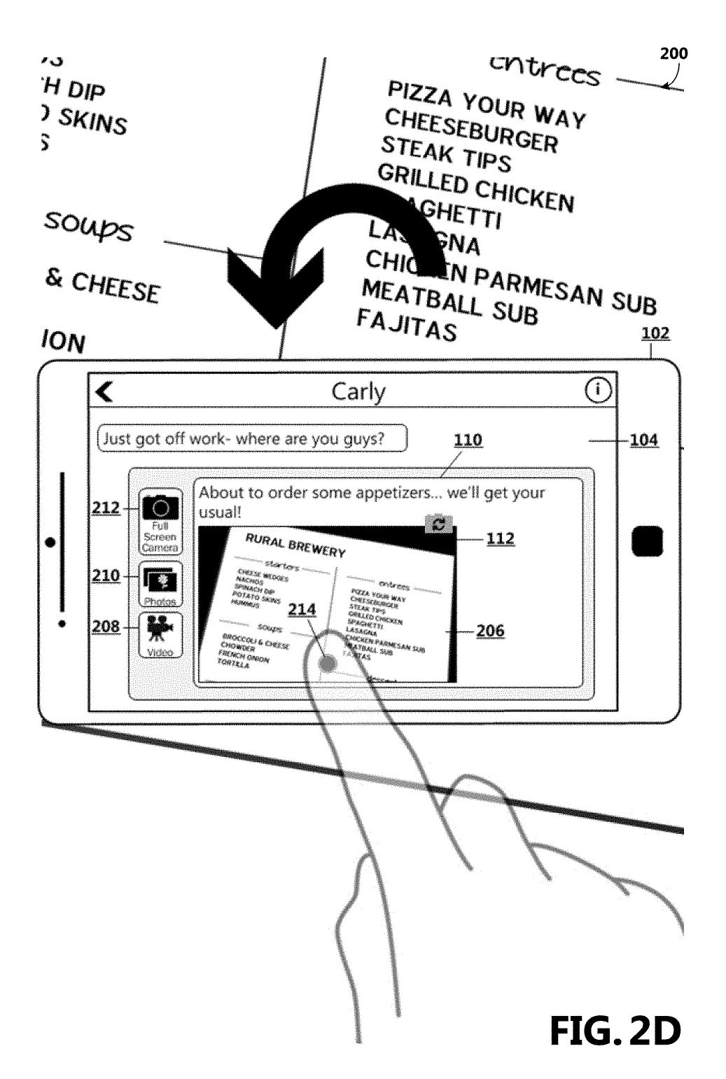

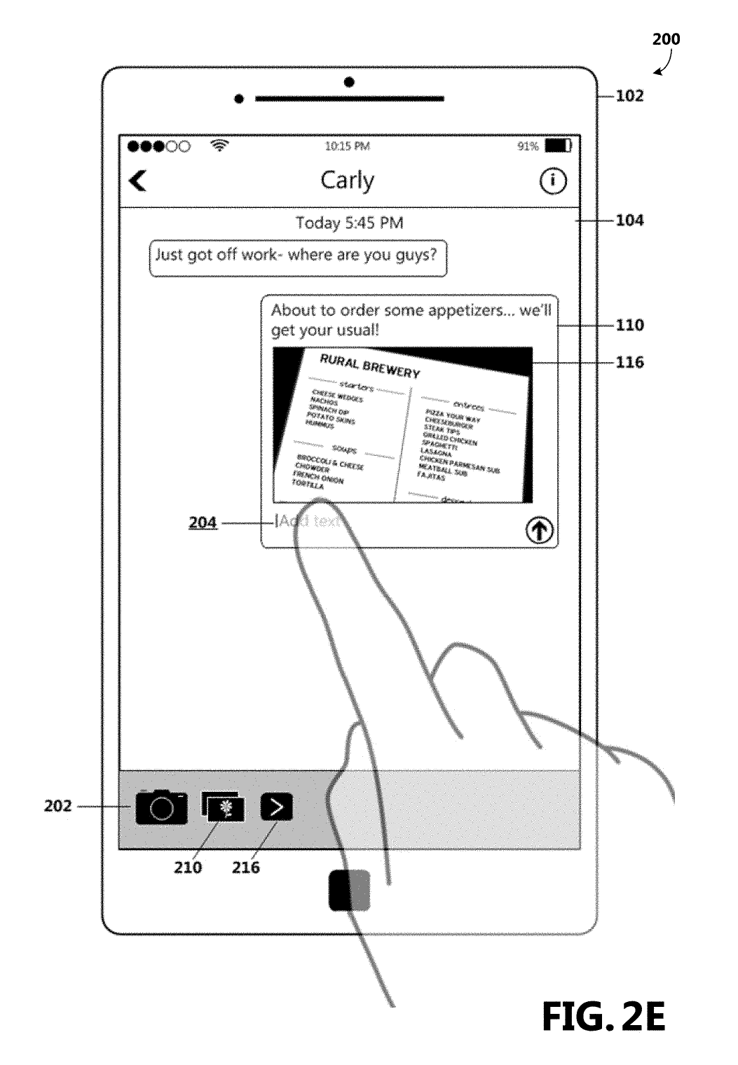

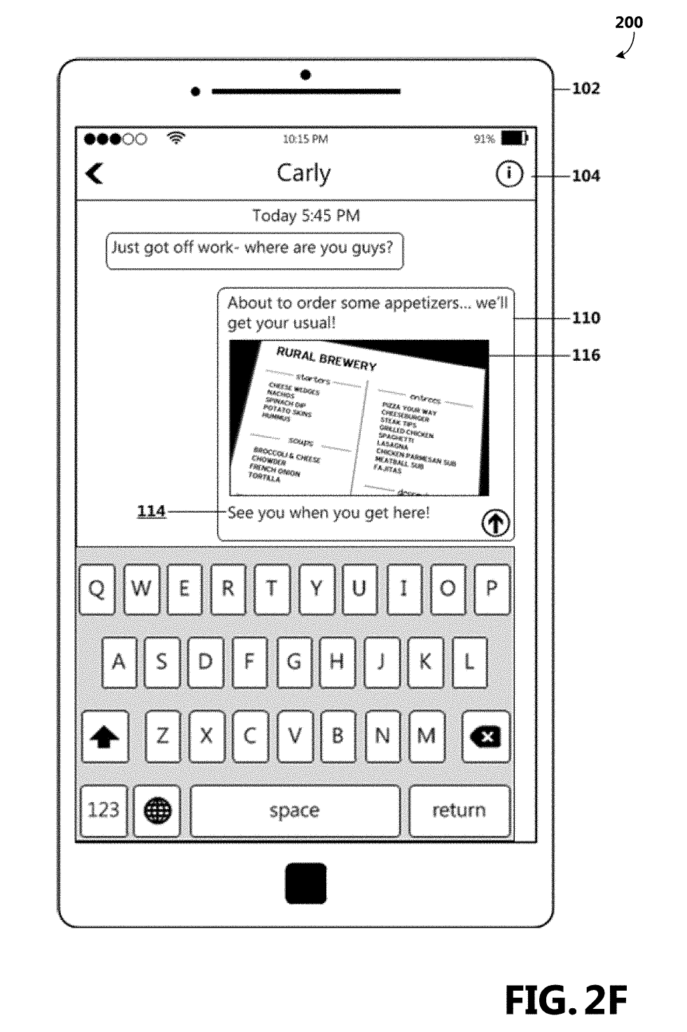

FIGS. 2A-2F illustrate an example UI storyboard 200 generated by aspects of a content authoring tool 108 showing a scenario where a user captures and inserts a photo in a message in a messaging application. Although the example UI storyboard 200 is shown on a phone, aspects of the disclosed technology may be utilized on various computing devices 102. With reference now to FIG. 2A, the user receives a message. A content authoring tool 108 embodied as a messaging application provides a GUI 104 that enables the user to view the received message and to generate and send a response to the received message. As illustrated, the user makes a selection to respond to the received message.

With reference now to FIG. 2B, the messaging application (content authoring tool 108) receives textual input from the user, which results in textual content 114 being added to the content authoring canvas 110, which is a message in the illustrated example. As illustrated, the insertion point 204 is displayed at the point where the next characters typed would appear in the content authoring canvas 110, and is represented by a vertical line, which may be a blinking vertical line when displayed on a computing device 102 display screen. The user then selects to capture and insert a photo (content element 116) into the message (content authoring canvas 110) by selecting a camera functionality command 202. In the example, the camera functionality command 202 is illustrated as a selectable user interface element that, when actuated, activates the camera tool 106 integrated with or communicatively attached to the computing device 102. Other types of camera functionality commands 202 (e.g., voice commands, hardware buttons, gestures) are possible and are within the scope of the present disclosure.

According to aspects and as illustrated in FIG. 2C, actuation of the camera functionality command 202 additionally causes the content authoring tool 108 to display an insertion viewport 112 associated with the selected camera functionality inline with the canvas content 114 at the insertion point 204 in the content authoring canvas 110. With the camera tool 106 activated, a preview 206 of an image seen through the lens of the camera tool 106 is displayed in the insertion viewport 112. Accordingly, the user is enabled to see how the photo (content element 116) looks within the context of the message (content authoring canvas 110) prior to committing to capture and insert the content element 116 in the message.

With reference now to FIG. 2D, the user has rotated the phone (computing device 102) ninety-degrees from a portrait orientation to a landscape orientation. In one example, the rotation is detectable by an internal gyroscope, accelerometer or other suitable means for detecting movement of the device 102. Responsive to the rotation, the messaging application (content authoring tool 108) updates the display to display the GUI 104 in the rotated orientation. According to an aspect and as illustrated, the content authoring tool 108 further rotates the insertion viewport 112 such that the viewport 112 is also in the landscape orientation. As shown, the preview 206 of the image seen through the lens of the camera tool 106 is also displayed in the landscape orientation, such that when the shutter of the camera tool 106 is activated, the resulting photo is a landscape image.

In some examples, one or more functionality options associated with the selected functionality (e.g., camera tool 106) are provided proximate to the insertion viewport 112, such as in a UI container comprising the insertion viewport 112 as illustrated in FIG. 2D. In other examples, one or more functionality options associated with the selected functionality are displayed in another location in the GUI 104. In the example illustrated in FIG. 2D, the functionality options include a video option 208 for activating video camera functionalities and enabling insertion of a video file in the content authoring canvas 110; a photos option 210 for enabling insertion of a photo stored in a data source 118, such as a photo album on the computing device 102 or on a server and accessible via a network; and a full-screen camera option 212 for expanding the size of the camera viewfinder, and thus the size of the preview image 206 and the insertion viewport 112. Other functionality options are possible and are within the scope of the present disclosure.

In some examples, when the full-screen camera option 212 is selected, the UI associated with the camera tool 106 is provided and displayed full-screen. In the illustrated example, the user selects to capture a photo of the image displayed as a preview image 206 in the insertion viewport 112. In some examples, a shutter button 214 is provided for taking a photo. In other examples, the insertion viewport 112 serves as the shutter button 214, wherein the insertion viewport becomes a hit target for activating the shutter. In other examples, the shutter is activated via another means (e.g., voice command, hardware button actuation, gesture).

With reference now to FIG. 2E, responsive to activating the shutter, the image is captured, and the photo of the image (content element 116) is inserted in the message (content authoring canvas 110) at the insertion point 204. After insertion of the content element 116, the insertion point 204 is moved to a position succeeding the inserted element (e.g., photo). The user may then add additional content 114 to the content authoring canvas 110 or send the message to an intended recipient. In one example, the camera functionality command 202 is displayed for enabling the user to take another photo and insert the photo into the message. In another example, the photos option 210 is displayed for enabling insertion of a photo stored in a data source 118, such as a photo album on the computing device 102 or on a server and accessible via a network. Alternatively or additionally, an options selector 216 may be provided for providing other functionalities or insertion options.

In the illustrated example, the user selects to add additional textual content 114 after the inserted photo (content element 116), for example, by selecting near the insertion point 204. With reference now to FIG. 2F, the additional inputted textual content 114 is added to the message (content authoring canvas 110) after the inserted photo (content element 116). The user may then select to add additional content 114, or may select to send the message.

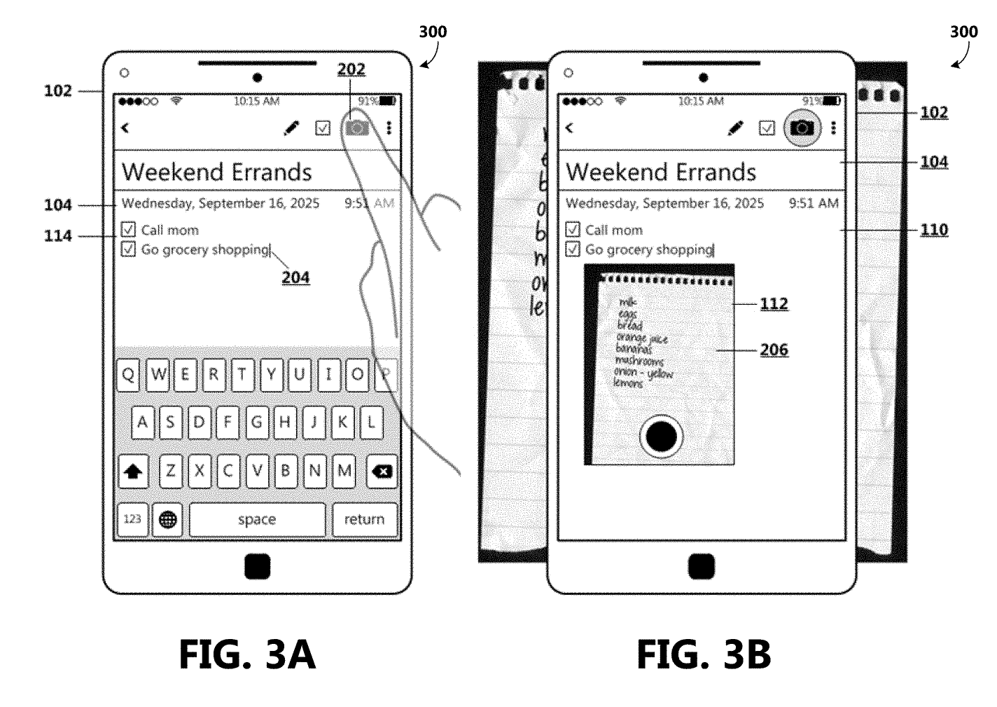

FIGS. 3A-3B illustrate an example UI storyboard 300 generated by aspects of a content authoring tool 108 showing a use case for capturing and inserting a photo in a content authoring canvas 110 embodied as a page in a notes-taking application (content authoring tool 108) on a phone computing device 102. As stated above, although the example UI storyboard 300 is shown on a phone, aspects of the disclosed technology may be utilized on various computing devices 102. With reference now to FIG. 3A, the notes-taking application provides a GUI 104 that enables the user to create, view, or edit a notes page (content authoring canvas 110). In the illustrated example, the user is creating a grocery list. As illustrated, the user makes a selection of the camera functionality command 202 to capture and insert a photo in the list. Like in example illustrated in FIG. 2A, the camera functionality command 202 is displayed as a selectable user interface element that, when actuated, activates the camera tool 106 integrated with or communicatively attached to the computing device 102. As should be appreciated, other types of camera functionality commands 202 (e.g., voice commands, hardware buttons, gestures) are possible and are within the scope of the present disclosure.

According to aspects and as illustrated in FIG. 3B, actuation of the camera functionality command 202 further causes the content authoring tool 108 to display an insertion viewport 112 associated with the selected camera functionality inline with the canvas content 114 at the insertion point 204 in the notes page (content authoring canvas 110). When the camera tool 106 is activated, a preview 206 of an image seen through the lens of the camera tool 106 is displayed in the insertion viewport 112. Accordingly, the user is enabled to see how the photo (content element 116) looks within the context of the notes page (content authoring canvas 110) prior to committing to capture and insert the content element 116 in the notes page. As illustrated, a shutter button 214 is provided for taking a photo. In other examples, the insertion viewport 112 serves as the shutter button 214, wherein the insertion viewport becomes a hit target for activating the shutter, or the shutter is activated via another means (e.g., voice command, hardware button actuation, gesture).

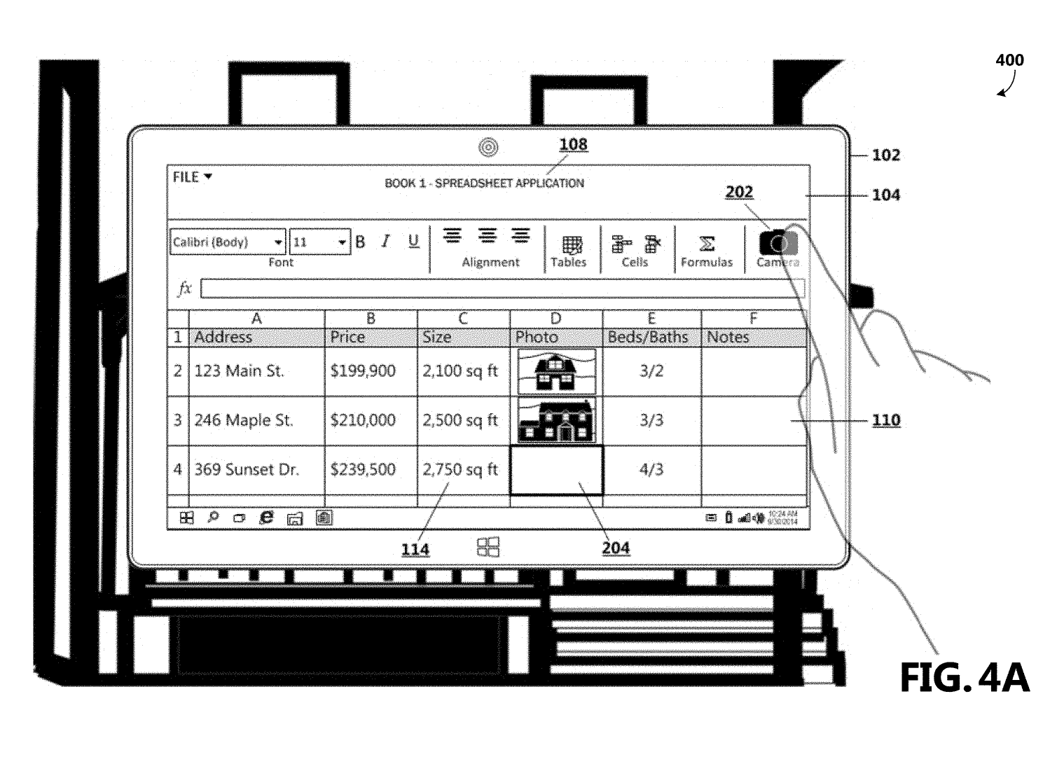

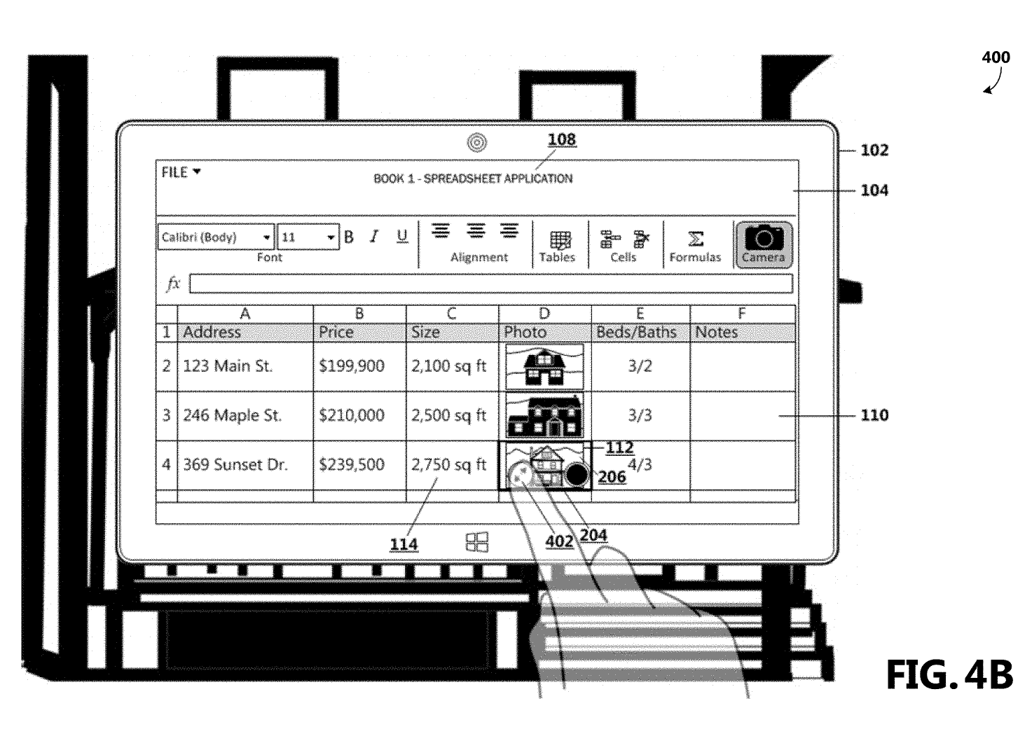

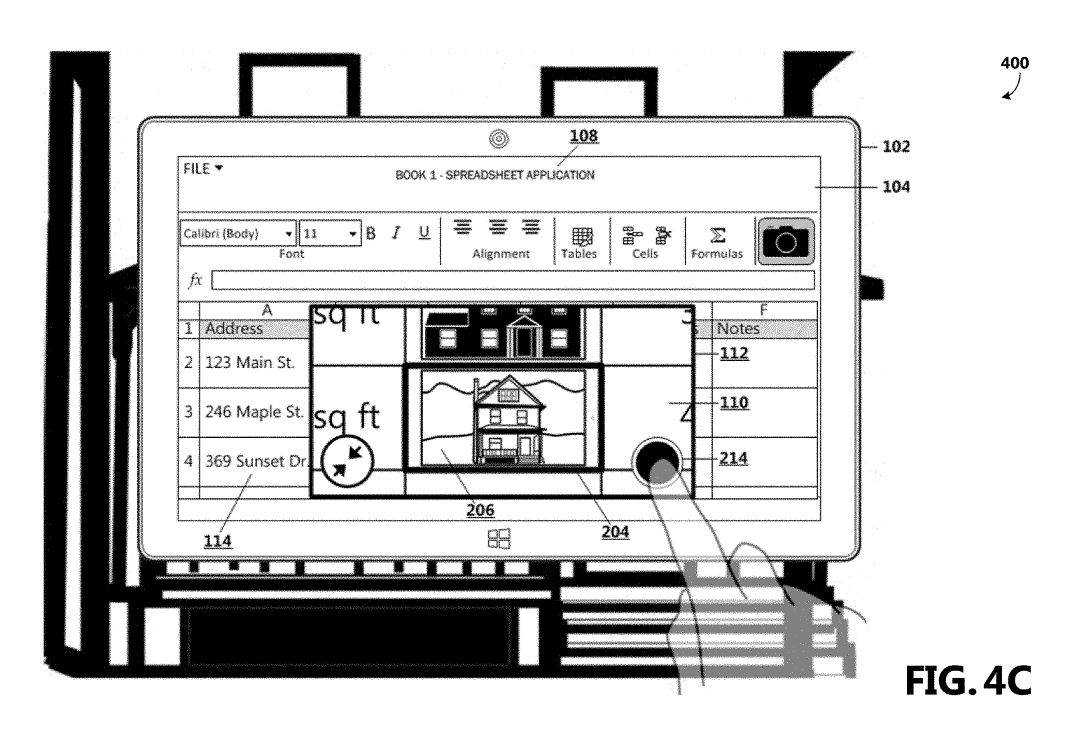

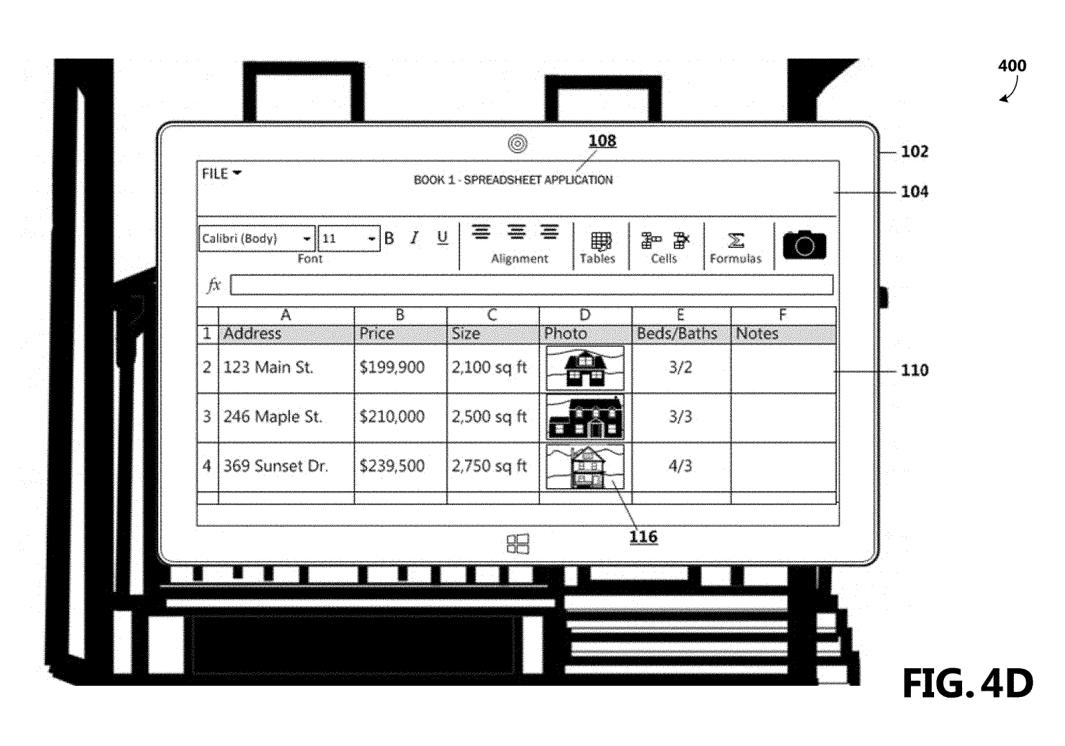

FIGS. 4A-4D illustrate an example UI storyboard 400 generated by aspects of a content authoring tool 108 showing a use case for capturing and inserting a photo in a content authoring canvas 110 embodied as a spreadsheet in a spreadsheet application (content authoring tool 108) on a tablet computing device 102. Although the example UI storyboard 400 is shown on a tablet, aspects of the disclosed technology may be utilized on various computing devices 102. With reference now to FIG. 4A, the spreadsheet application provides a GUI 104 that enables the user to create, view, or edit a spreadsheet (content authoring canvas 110). In the illustrated example, the user is taking and inserting photos of houses in a spreadsheet table. As illustrated, the user selects the camera functionality command 202 displayed in a toolbar to take and insert another photo into the table. Like in the examples illustrated in FIGS. 2A and 3A, the camera functionality command 202 is displayed as a selectable user interface element which, when actuated, activates the camera tool 106 integrated with or communicatively attached to the computing device 102. As should be appreciated, other types of camera functionality commands 202 are possible and are within the scope of the present disclosure.

According to aspects and as illustrated in FIG. 4B, actuation of the camera functionality command 202 further causes the content authoring tool 108 to display an insertion viewport 112 associated with the selected camera functionality inline with the canvas content 114 at the insertion point 204 in the spreadsheet (content authoring canvas 110). In some examples, such as when utilizing a spreadsheet application, a selected cell within the spreadsheet defined by the intersection of a row and column may function as the insertion point 204. For example, a cell may be referenced by a letter and number combination. When the camera tool 106 is activated, a preview 206 of an image seen through the lens of the camera tool 106 is displayed in the insertion viewport 112. Accordingly, the user is enabled to see how the photo (content element 116) looks within the context of the spreadsheet (content authoring canvas 110) prior to committing to capture and insert the content element in the spreadsheet. In some examples, a cell may resize to fit to the size of an inserted content element 116. As should be appreciated, the content element 116 may be inserted into a spreadsheet canvas that is not divided into one or more cells. In some examples, a size option 402 is provided for expanding or reducing the size of the insertion viewport 112. In the example illustrated in FIG. 4B, the user selects the size option 402.

Responsive to the size option selection and with reference now to FIG. 4C, the content authoring tool 108 enlarges the insertion viewport 112 within the context of the content authoring canvas 110. According to an aspect, the preview image 206 is enlarged consistently with the size of the insertion viewport 112. According to another aspect, content 114 surrounding the insertion point 204 is likewise enlarged, such that the preview image 206 remains in context with at least a portion of the content authoring canvas 110.

In the illustrated example, the user selects to capture a photo of the image displayed as a preview image 206 in the insertion viewport 112. In some examples, a shutter button 214 is provided for taking a photo. In other examples, the insertion viewport 112 serves as the shutter button 214, wherein the insertion viewport becomes a hit target for activating the shutter. In other examples, the shutter is activated via another means (e.g., voice command, hardware button actuation, gesture). With reference now to FIG. 4D, responsive to activating the shutter, the image is captured, and the photo of the image (content element 116) is inserted in the spreadsheet (content authoring canvas 110) at the insertion point 204 (e.g., in the selected cell).

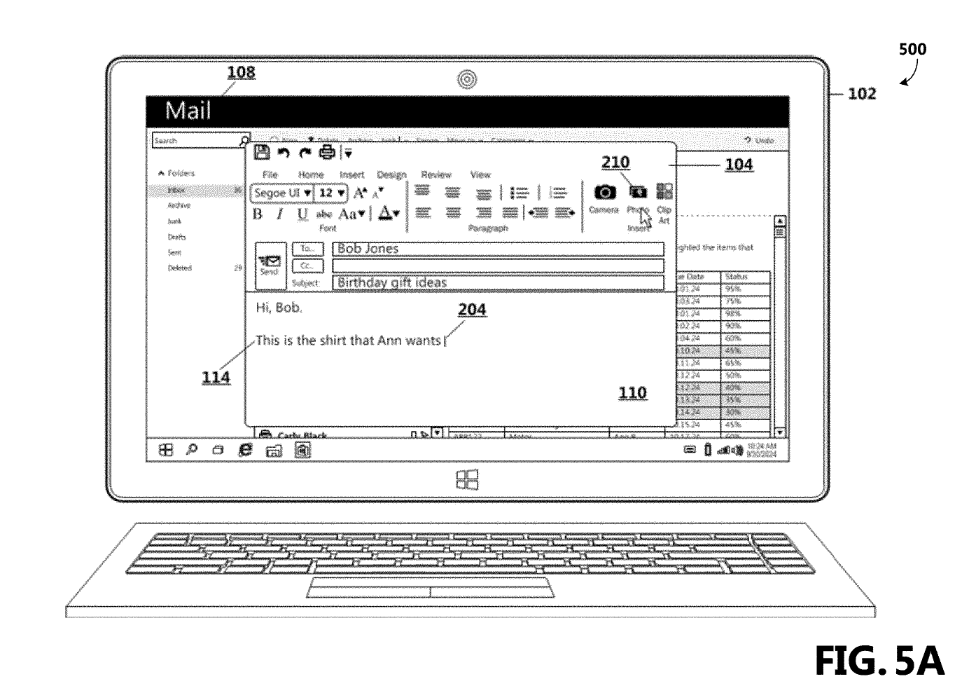

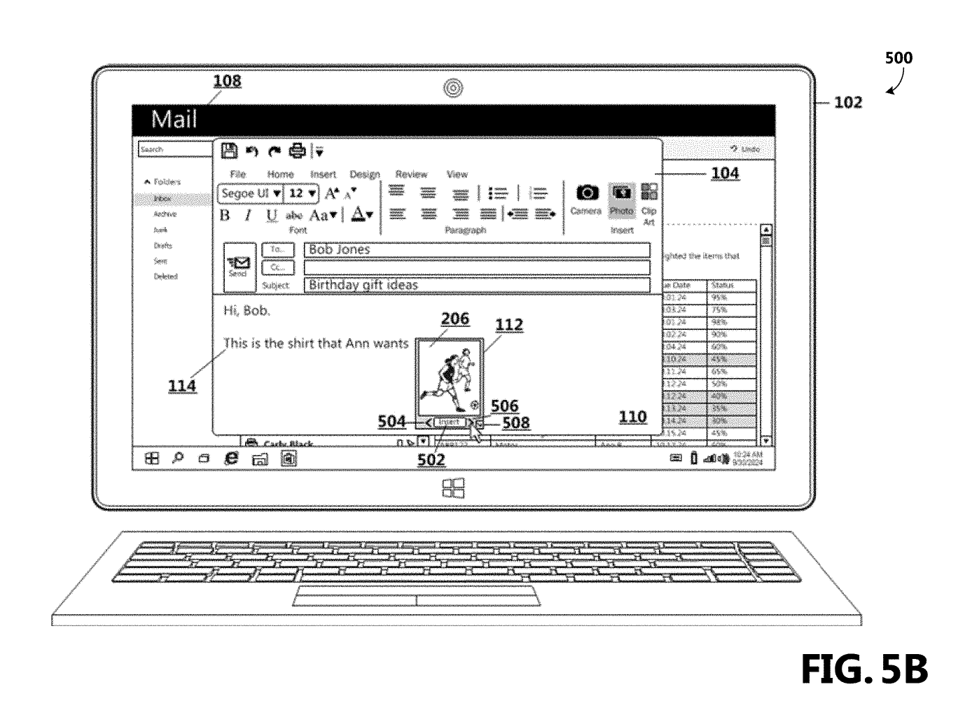

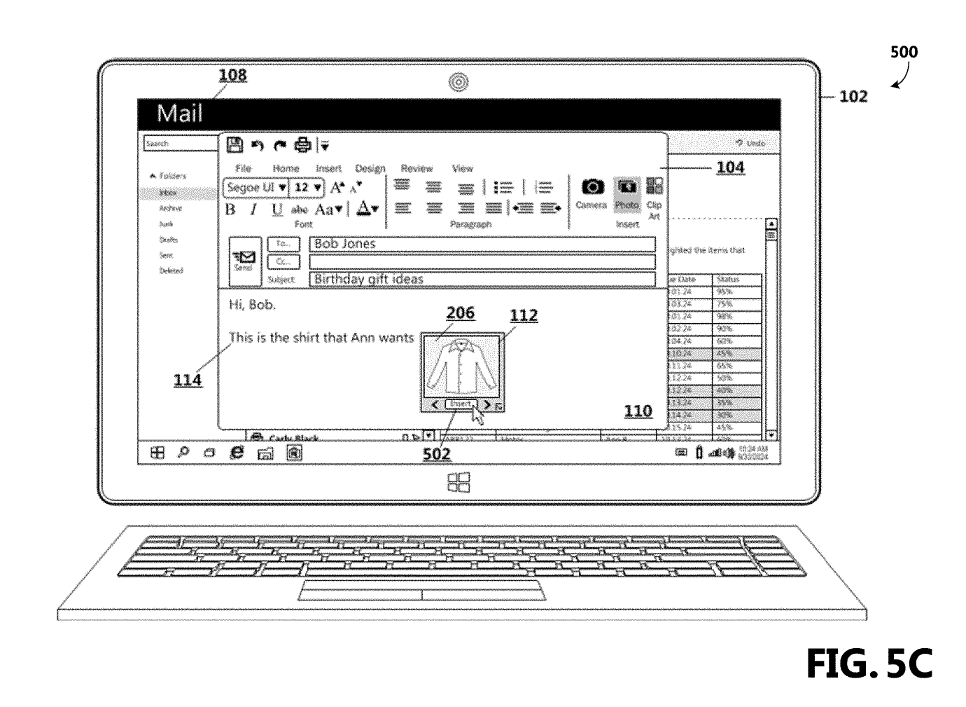

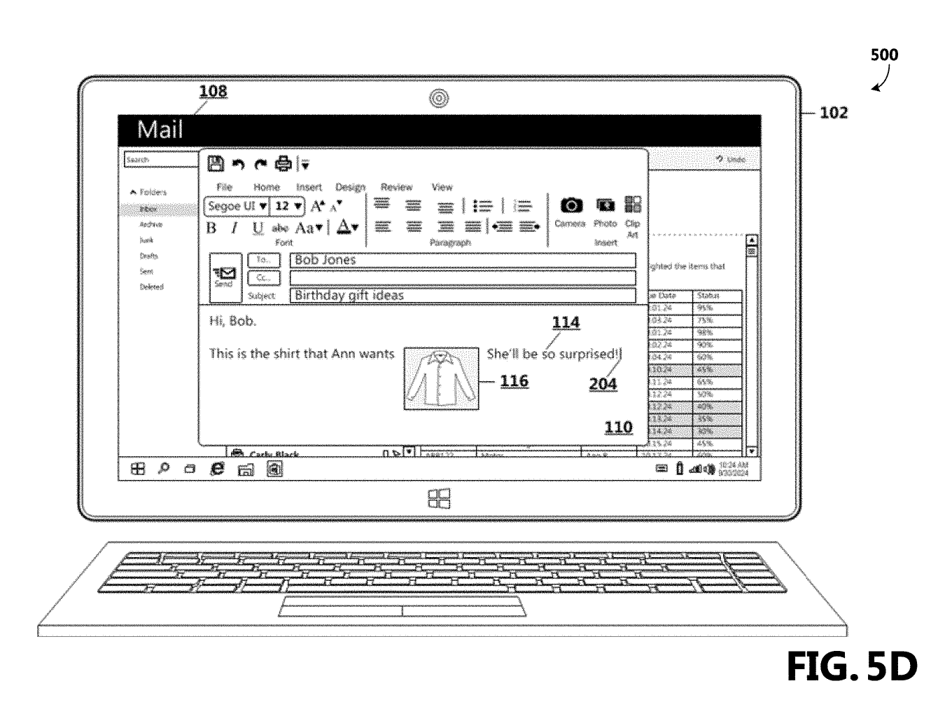

FIGS. 5A-5D illustrate an example UI storyboard 500 generated by aspects of a content authoring tool 108 showing a use case for selecting and inserting a stored photo (content element 116) in a content authoring canvas 110 embodied as an email message in an email application (content authoring tool 108) on a laptop computing device 102. Although the example UI storyboard 500 is shown on a laptop computing device 102, aspects of the disclosed technology may be utilized on various types of computing devices. With reference now to FIG. 5A, the email application provides a GUI 104 that enables the user to create and send an email message (content authoring canvas 110) to an intended recipient. As illustrated, via a user input method, the user selects the photos option 210 displayed in a toolbar to insert a photo into the message. In the example illustrated in FIG. 5A, the photos option 210 is displayed as a selectable user interface element that, when actuated, enables insertion of a photo (content element 116) stored in a data source 118, such as a folder or photo album stored on the computing device 102 or on a server and accessible via a network. As should be appreciated, other types of photos option commands are possible and are within the scope of the present disclosure.

According to aspects and with reference now to FIG. 5B, actuation of the photos option 210 causes the content authoring tool 108 to display an insertion viewport 112 associated with the selected photo insertion functionality inline with the canvas content 114 at the insertion point 204 in the email message (content authoring canvas 110). As illustrated, a preview 206 of a photo stored in a data source 118 is displayed in the insertion viewport 112. Accordingly, the user is enabled to see how the photo (content element 116) looks within the context of the email message (content authoring canvas 110) prior to committing to select and insert the photo in the email message. According to an aspect, an insert command 502 is provided, which when selected, inserts the photo (content element 116), displayed as a preview image 206 in the insertion viewport 112, into the email message (content authoring canvas 110). In some examples, a previous selector 504 and a next selector 506 are provided for enabling the user to scroll or navigate through photos stored in the data source 118. Alternatively or additionally, the user may be enabled to scroll or navigate through photos stored in the data source 118 via swiping across the photo preview 206 displayed in the insertion viewport 112. Alternatively or additionally, an option 508 may be provided for enabling the user to view additional options, such as selecting a data source 118, filtering photos, etc.

In the illustrated example, the user selects the next selector 506 to view a preview image 206 of a next photo stored in the data source 118. Responsive to the next selection and with reference now to FIG. 5C, a preview image 206 of the next photo in the data source 118 is displayed in the insertion viewport 112. As illustrated, the user selects the insert command 502. Responsive to the insert command selection and with reference now to FIG. 5D, the photo (content element 116) displayed as a preview image 206 in the insertion viewport 112 is inserted into the email message (content authoring canvas 110) at the insertion point 204. After insertion of the content element 116, the insertion point 204 is moved to a position after the inserted element (e.g., photo). The user selects to add additional textual content 114 after the inserted photo (content element 116), for example, by typing keys on a keyboard. As illustrated, the additional inputted textual content 114 is added to the message (content authoring canvas 110) after the inserted photo (content element 116). The user may then select to add additional content 114, or select to send the message.

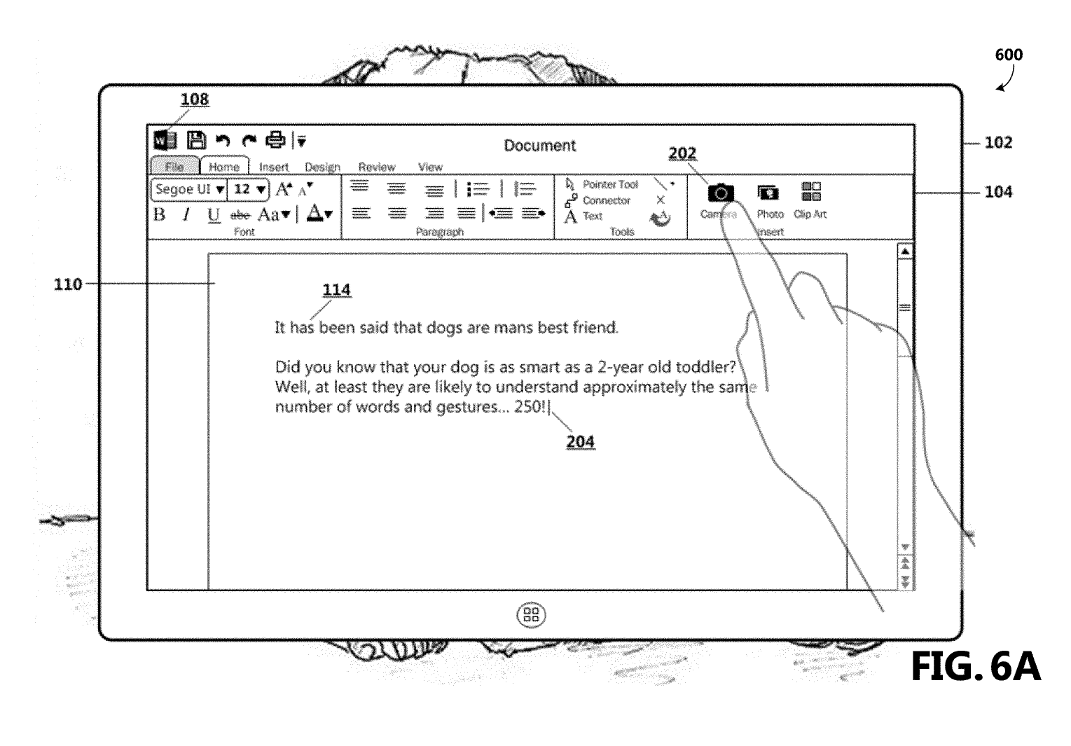

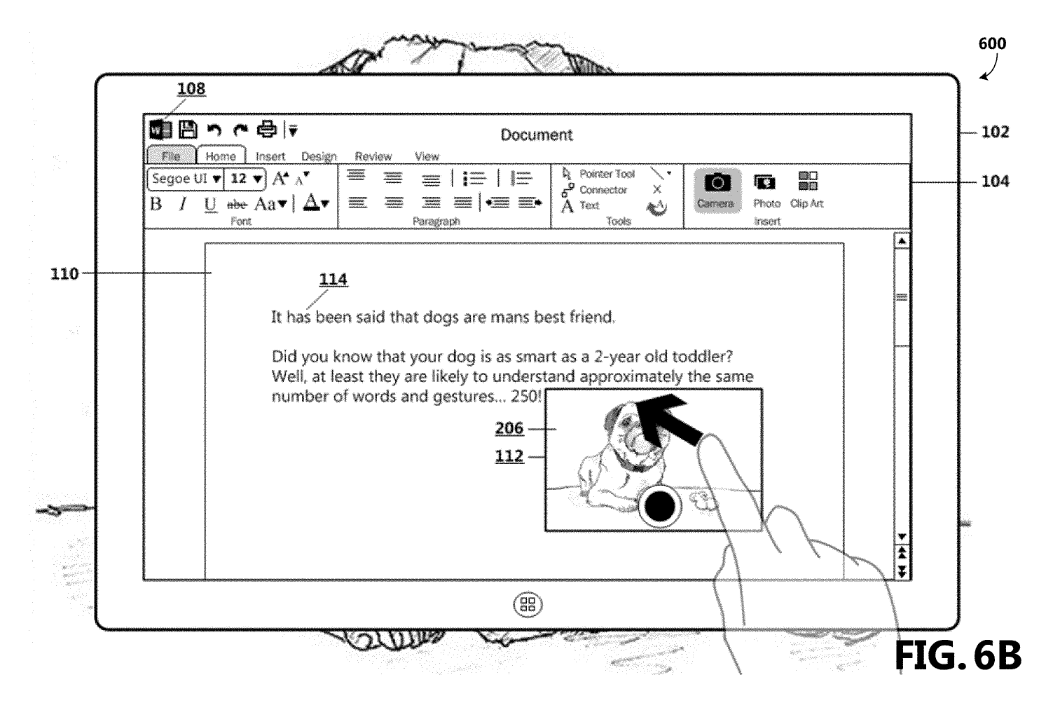

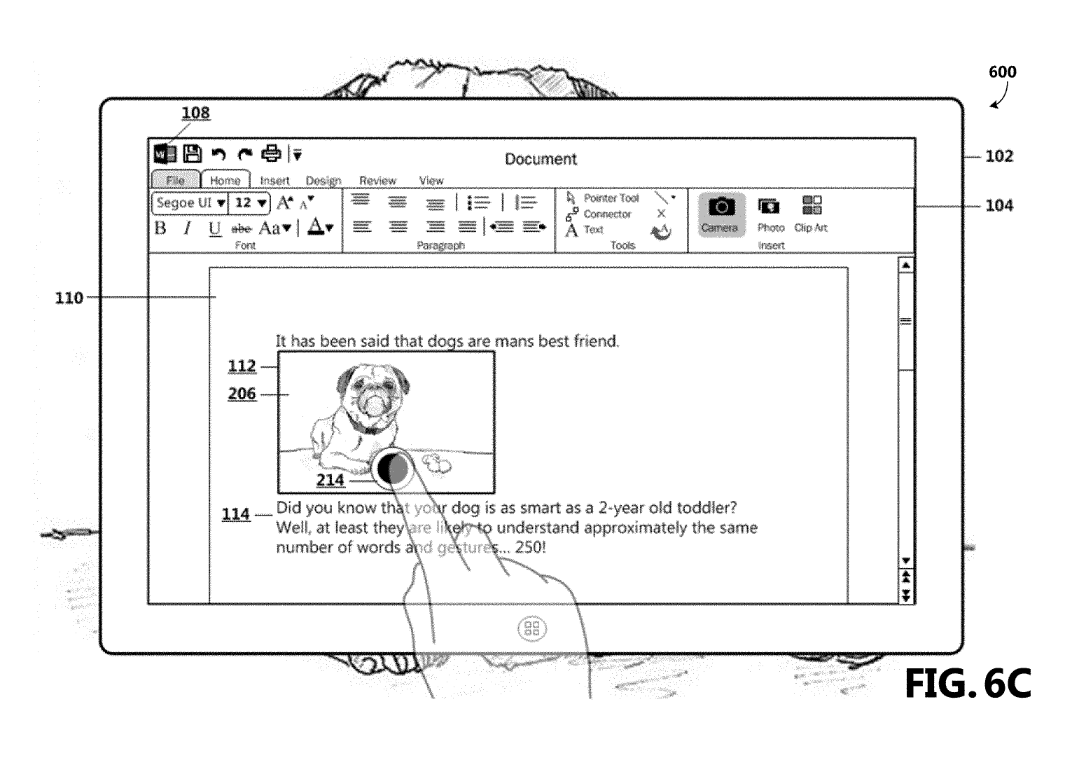

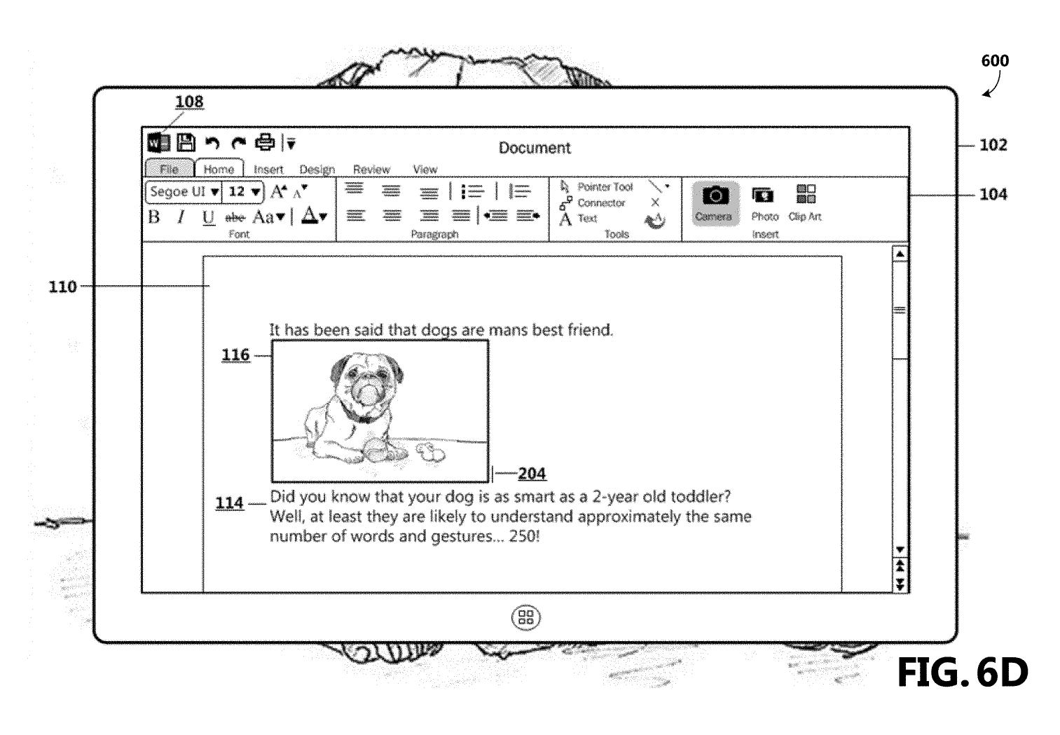

FIGS. 6A-6D illustrate an example UI storyboard 600 generated by aspects of a content authoring tool 108 showing a use case for capturing a photo (content element 116) in a content authoring canvas 110 embodied as a document in a word processing application (content authoring tool 108) on a tablet computing device 102, and re-anchoring the insertion viewport 112 prior to insertion of the photo. Although the example UI storyboard 600 is shown on a tablet, aspects of the disclosed technology may be utilized on various computing devices 102. With reference now to FIG. 6A, the word processing application provides a GUI 104 that enables the user to create, view, or edit a document (content authoring canvas 110). In the illustrated example, the user is writing a paper. As illustrated, the user selects a camera functionality command 202 displayed in a toolbar to capture and insert a photo of an image into the canvas 110. In the illustrated example, the camera functionality command 202 is displayed as a selectable user interface element that, when actuated, causes the content authoring tool 108 to display an insertion viewport 112 associated with the selected camera functionality inline with the canvas content 114 at the insertion point 204 in the document (content authoring canvas 110). As should be appreciated, other types of camera functionality commands 202 are possible and are within the scope of the present disclosure.

As illustrated in FIG. 6B, a preview 206 of an image seen through the lens of the camera tool 106 is displayed in the insertion viewport 112. Accordingly, the user is enabled to see how the photo (content element 116) looks within the context of the document (content authoring canvas 110) prior to committing to capture and insert the content element 116 in the document. According to an aspect and as illustrated, the user is enabled to drag the insertion viewport 112 to another location or position in the canvas 110. Responsive to the drag input and with reference now to FIG. 6C, the insertion point 204 and the insertion viewport 112 are moved to the selected location or position, and the canvas content 114 is adjusted based on the new position of the insertion point 204 and insertion viewport 112. For example, the canvas content 114 adapts to the photo preview 206 location, thus providing a preview of the layout of the canvas 110 and the photo prior to committing to inserting the photo (content element 116) into the canvas 110.

In the illustrated example, the user selects to capture a photo of the image displayed as a preview image 206 in the insertion viewport 112. In some examples, a shutter button 214 is provided for taking a photo. In other examples, the insertion viewport 112 serves as the shutter button 214, wherein the insertion viewport becomes a hit target for activating the shutter. In other examples, the shutter is activated via another means (e.g., voice command, hardware button actuation, gesture).

With reference now to FIG. 6D, responsive to activating the shutter, the image is captured, and the photo of the image (content element 116) is inserted in the message (content authoring canvas 110) at the new insertion point 204 location. After insertion of the content element 116, the insertion point 204 may be moved to a position after the inserted element (e.g., photo), or alternatively, the insertion point 204 may be moved back to its previous location prior to the content element insertion.

Having described an example operating environment 100 including a system for providing an inline insertion viewport 112 and various user interface examples generated by aspects of a content authoring tool 108 with respect to FIGS. 1-6D, FIG. 7 is a flow chart showing general stages involved in an example method 700 for providing an inline insertion viewport 112 for improved usability of a content authoring tool 108 that enables a preview 206 of an insertion of a content element 116 within the context of a content authoring canvas 110 prior to insertion of the content element 116 into the canvas 110.

The method 700 starts at OPERATION 702, and proceeds to OPERATION 704, where a content authoring canvas 110 is displayed in a GUI 104 of a content authoring tool 108. For example, the content authoring canvas 110 may be a page of a notebook or word processing document, a spreadsheet of a workbook, a slide of a slide presentation, an email message, a text message, an instant message, another communication message type, a web page of a website, a mobile or web application interface, or other type of canvas.

The method 700 proceeds to OPERATION 706, where a user selection of a functionality associated with inserting a content element 116 at the current insertion point 204 in the content authoring canvas 110 is received. For example, the user may select a selectable functionality command, such as a displayed selector or a hardware button. In other examples, the user may utilize another type of input method, such as a voice command or a gesture input associated with inserting a content element 116 at the current insertion point 204 in the content authoring canvas 110. In some examples, the functionality selection is associated with taking and inserting a photo using the camera tool 106 integrated with or communicatively attached to the computing device 102. In other examples, the functionality selection is associated with inserting a stored photo, video, clip art image, shape, chart, or other content element 116 into the content authoring canvas 110.

Responsive to the user selection at OPERATION 706, the method 700 proceeds to OPERATION 708, where the selected functionality is activated. For example, when the functionality selection is associated with taking and inserting a photo, the camera tool 106 is activated. As another example, when the functionality selection is associated with inserting a clip art image, a clip art insertion functionality is activated. As another example, when the functionality selection is associated with inserting a stored photo, a photo insertion functionality is activated.

At OPERATION 710, an insertion viewport 112 associated with the selected functionality is displayed at the insertion point 204 in the content authoring canvas 110. That is, the insertion viewport 112 is displayed inline in the content authoring canvas 110 at the point where the next characters typed would appear on the screen, providing a preview 206 of a content element 116 in the context of the canvas 110 and the canvas content 114 prior to insertion into the canvas 110. For example, when the camera functionality is selected, a preview of an image seen through the lens of a built-in or communicatively attached camera is displayed in the insertion viewport 112, enabling the user to see how the photo looks within the context of the canvas 110 prior to committing to capture and insert the content element in the message. Additional options may be provided, for example, for enabling the user to: scroll or navigate through other content elements 116, search for content elements 116 meeting input search criteria, change a data source 118 in which content elements 116 may be stored, resize the insertion viewport 112, etc. According to an aspect, the user may move or drag the insertion viewport 112 to another location in the canvas 110, thus moving the insertion point 204 to the other location, re-anchoring the position of the insertion viewport 112, and re-arranging the order between the insertion viewport 112 and the canvas content 114.

At OPERATION 712, a user selection of a content element 116 is received. For example, the user may select to activate the shutter of the camera tool 106 for taking a photo and inserting the image in the content authoring canvas 110. In other examples, the user may select a clip art image, a photo, a shape, a chart, or other content element 116 represented as a preview image displayed in the insertion viewport 112.

Responsive to the user selection at OPERATION 712, method 700 proceeds to OPERATION 714, where the selected content element 116 is inserted into the content authoring canvas 110 at the insertion point 204. Further, the insertion viewport 112 is removed from the GUI 104, and the insertion point 204 is moved to a next available character space following the inserted content element 116. The method 700 ends at OPERATION 798.

While implementations have been described in the general context of program modules that execute in conjunction with an application program that runs on an operating system on a computer, those skilled in the art will recognize that aspects may also be implemented in combination with other program modules. Generally, program modules include routines, programs, components, data structures, and other types of structures that perform particular tasks or implement particular abstract data types.

The aspects and functionalities described herein may operate via a multitude of computing systems including, without limitation, desktop computer systems, wired and wireless computing systems, mobile computing systems (e.g., mobile telephones, netbooks, tablet or slate type computers, notebook computers, and laptop computers), hand-held devices, multiprocessor systems, microprocessor-based or programmable consumer electronics, minicomputers, and mainframe computers.

In addition, according to an aspect, the aspects and functionalities described herein operate over distributed systems (e.g., cloud-based computing systems), where application functionality, memory, data storage and retrieval and various processing functions are operated remotely from each other over a distributed computing network, such as the Internet or an intranet. According to an aspect, user interfaces and information of various types are displayed via on-board computing device displays or via remote display units associated with one or more computing devices. For example, user interfaces and information of various types are displayed and interacted with on a wall surface onto which user interfaces and information of various types are projected. Interaction with the multitude of computing systems with which implementations are practiced include, keystroke entry, touch screen entry, voice or other audio entry, gesture entry where an associated computing device is equipped with detection (e.g., camera) functionality for capturing and interpreting user gestures for controlling the functionality of the computing device, and the like.

FIGS. 8-10 and the associated descriptions provide a discussion of a variety of operating environments in which examples are practiced. However, the devices and systems illustrated and discussed with respect to FIGS. 8-10 are for purposes of example and illustration and are not limiting of a vast number of computing device configurations that are utilized for practicing aspects, described herein.

FIG. 8 is a block diagram illustrating physical components (i.e., hardware) of a computing device 800 with which examples of the present disclosure may be practiced. In a basic configuration, the computing device 800 includes at least one processing unit 802 and a system memory 804. According to an aspect, depending on the configuration and type of computing device, the system memory 804 comprises, but is not limited to, volatile storage (e.g., random access memory), non-volatile storage (e.g., read-only memory), flash memory, or any combination of such memories. According to an aspect, the system memory 804 includes an operating system 805 and one or more program modules 806 suitable for running software applications 850. According to an aspect, the system memory 804 includes the content authoring tool 108 and the camera tool 106. The operating system 805, for example, is suitable for controlling the operation of the computing device 800. Furthermore, aspects are practiced in conjunction with a graphics library, other operating systems, or any other application program, and are not limited to any particular application or system. This basic configuration is illustrated in FIG. 8 by those components within a dashed line 808. According to an aspect, the computing device 800 has additional features or functionality. For example, according to an aspect, the computing device 800 includes additional data storage devices (removable and/or non-removable) such as, for example, magnetic disks, optical disks, or tape. Such additional storage is illustrated in FIG. 8 by a removable storage device 809 and a non-removable storage device 810.

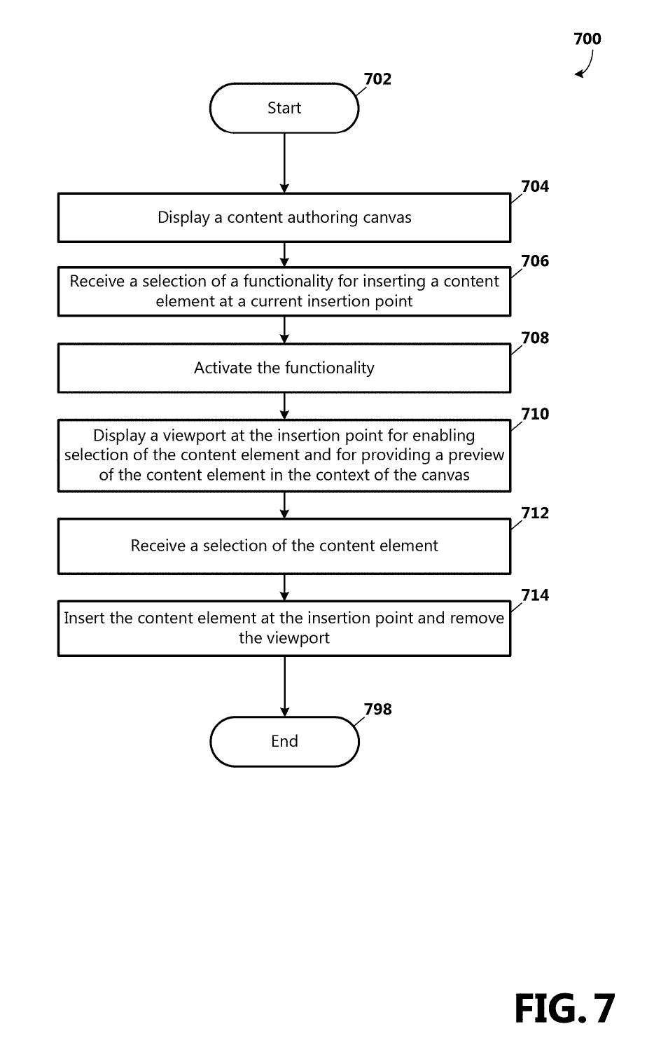

As stated above, according to an aspect, a number of program modules and data files are stored in the system memory 804. While executing on the processing unit 802, the program modules 806 (e.g., content authoring tool 108 and camera tool 106) perform processes including, but not limited to, one or more of the stages of the method 700 illustrated in FIG. 7. According to an aspect, other program modules are used in accordance with examples and include applications such as electronic mail and contacts applications, word processing applications, spreadsheet applications, database applications, slide presentation applications, drawing or computer-aided application programs, etc.

According to an aspect, aspects are practiced in an electrical circuit comprising discrete electronic elements, packaged or integrated electronic chips containing logic gates, a circuit utilizing a microprocessor, or on a single chip containing electronic elements or microprocessors. For example, aspects are practiced via a system-on-a-chip (SOC) where each or many of the components illustrated in FIG. 8 are integrated onto a single integrated circuit. According to an aspect, such an SOC device includes one or more processing units, graphics units, communications units, system virtualization units and various application functionality all of which are integrated (or “burned”) onto the chip substrate as a single integrated circuit. When operating via an SOC, the functionality, described herein, is operated via application-specific logic integrated with other components of the computing device 800 on the single integrated circuit (chip). According to an aspect, aspects of the present disclosure are practiced using other technologies capable of performing logical operations such as, for example, AND, OR, and NOT, including but not limited to mechanical, optical, fluidic, and quantum technologies. In addition, aspects are practiced within a general purpose computer or in any other circuits or systems.

According to an aspect, the computing device 800 has one or more input device(s) 812 such as a keyboard, a mouse, a pen, a sound input device, a touch input device, etc. The output device(s) 814 such as a display, speakers, a printer, etc. are also included according to an aspect. The aforementioned devices are examples and others may be used. According to an aspect, the computing device 800 includes one or more communication connections 816 allowing communications with other computing devices 818. Examples of suitable communication connections 816 include, but are not limited to, radio frequency (RF) transmitter, receiver, and/or transceiver circuitry; universal serial bus (USB), parallel, and/or serial ports.

The term computer readable media as used herein include computer storage media. Computer storage media include volatile and nonvolatile, removable and non-removable media implemented in any method or technology for storage of information, such as computer readable instructions, data structures, or program modules. The system memory 804, the removable storage device 809, and the non-removable storage device 810 are all computer storage media examples (i.e., memory storage.) According to an aspect, computer storage media includes RAM, ROM, electrically erasable programmable read-only memory (EEPROM), flash memory or other memory technology, CD-ROM, digital versatile disks (DVD) or other optical storage, magnetic cassettes, magnetic tape, magnetic disk storage or other magnetic storage devices, or any other article of manufacture which can be used to store information and which can be accessed by the computing device 800. According to an aspect, any such computer storage media is part of the computing device 800. Computer storage media does not include a carrier wave or other propagated data signal.

According to an aspect, communication media is embodied by computer readable instructions, data structures, program modules, or other data in a modulated data signal, such as a carrier wave or other transport mechanism, and includes any information delivery media. According to an aspect, the term “modulated data signal” describes a signal that has one or more characteristics set or changed in such a manner as to encode information in the signal. By way of example, and not limitation, communication media includes wired media such as a wired network or direct-wired connection, and wireless media such as acoustic, radio frequency (RF), infrared, and other wireless media.

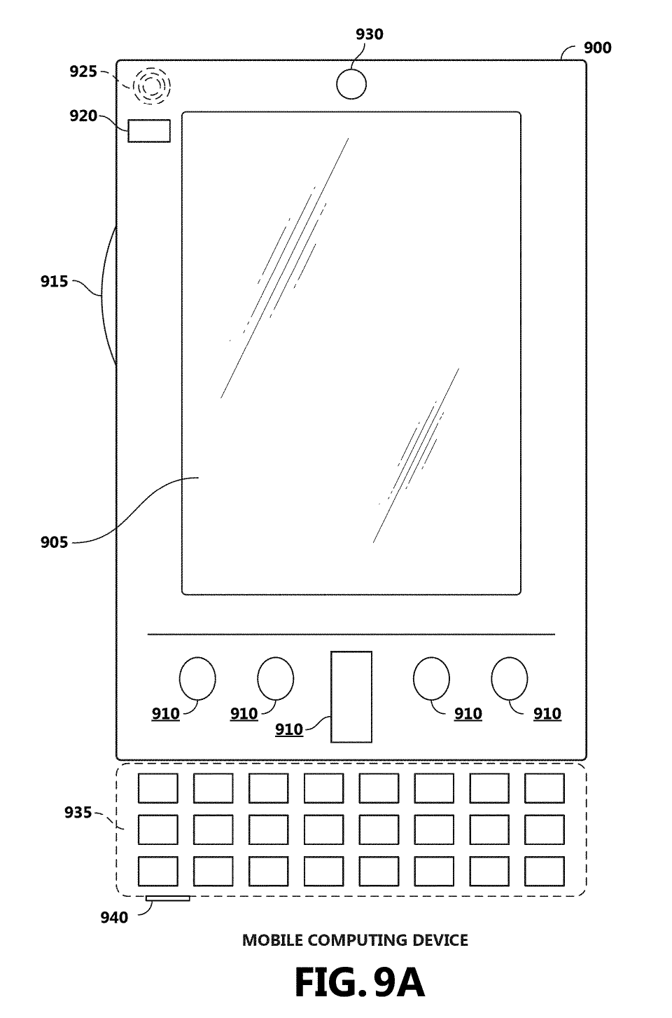

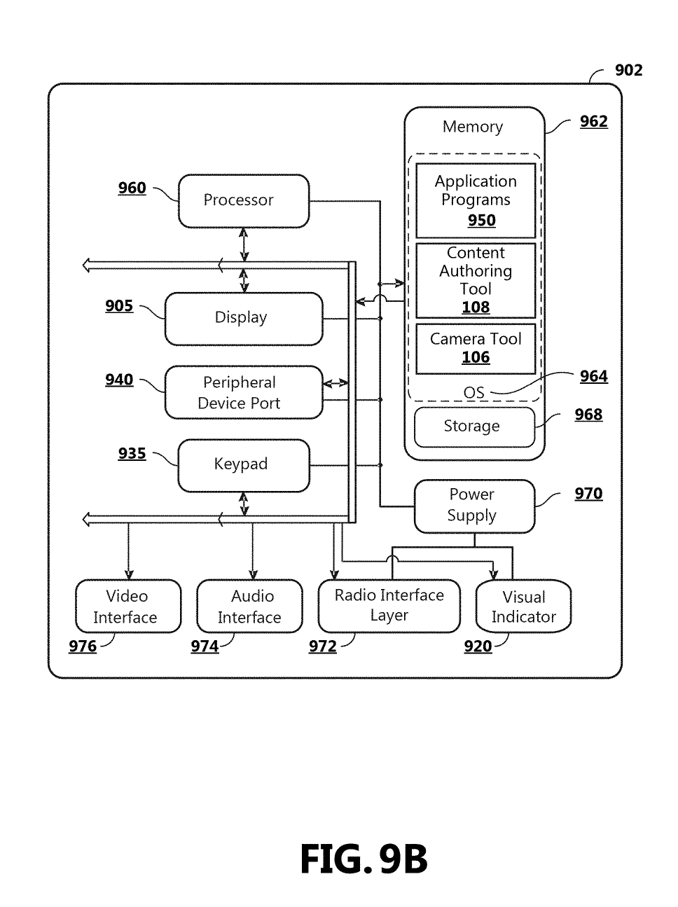

FIGS. 9A and 9B illustrate a mobile computing device 900, for example, a mobile telephone, a smart phone, a tablet personal computer, a laptop computer, and the like, with which aspects may be practiced. With reference to FIG. 9A, an example of a mobile computing device 900 for implementing the aspects is illustrated. In a basic configuration, the mobile computing device 900 is a handheld computer having both input elements and output elements. The mobile computing device 900 typically includes a display 905 and one or more input buttons 910 that allow the user to enter information into the mobile computing device 900. According to an aspect, the display 905 of the mobile computing device 900 functions as an input device (e.g., a touch screen display). If included, an optional side input element 915 allows further user input. According to an aspect, the side input element 915 is a rotary switch, a button, or any other type of manual input element. In alternative examples, mobile computing device 900 incorporates more or less input elements. For example, the display 905 may not be a touch screen in some examples. In alternative examples, the mobile computing device 900 is a portable phone system, such as a cellular phone. According to an aspect, the mobile computing device 900 includes an optional keypad 935. According to an aspect, the optional keypad 935 is a physical keypad. According to another aspect, the optional keypad 935 is a “soft” keypad generated on the touch screen display. In various aspects, the output elements include the display 905 for showing a graphical user interface (GUI), a visual indicator 920 (e.g., a light emitting diode), and/or an audio transducer 925 (e.g., a speaker). In some examples, the mobile computing device 900 incorporates a vibration transducer for providing the user with tactile feedback. In yet another example, the mobile computing device 900 incorporates input and/or output ports, such as an audio input (e.g., a microphone jack), an audio output (e.g., a headphone jack), and a video output (e.g., a HDMI port) for sending signals to or receiving signals from an external device. In yet another example, the mobile computing device 900 incorporates peripheral device port 940, such as an audio input (e.g., a microphone jack), an audio output (e.g., a headphone jack), and a video output (e.g., a HDMI port) for sending signals to or receiving signals from an external device.

FIG. 9B is a block diagram illustrating the architecture of one example of a mobile computing device. That is, the mobile computing device 900 incorporates a system (i.e., an architecture) 902 to implement some examples. In one example, the system 902 is implemented as a “smart phone” capable of running one or more applications (e.g., browser, e-mail, calendaring, contact managers, messaging clients, games, and media clients/players). In some examples, the system 902 is integrated as a computing device, such as an integrated personal digital assistant (PDA) and wireless phone.

According to an aspect, one or more application programs 950 are loaded into the memory 962 and run on or in association with the operating system 964. Examples of the application programs include phone dialer programs, e-mail programs, personal information management (PIM) programs, word processing programs, spreadsheet programs, Internet browser programs, messaging programs, and so forth. According to an aspect, the content authoring tool 108 and camera tool 106 are loaded into memory 962. The system 902 also includes a non-volatile storage area 968 within the memory 962. The non-volatile storage area 968 is used to store persistent information that should not be lost if the system 902 is powered down. The application programs 950 may use and store information in the non-volatile storage area 968, such as e-mail or other messages used by an e-mail application, and the like. A synchronization application (not shown) also resides on the system 902 and is programmed to interact with a corresponding synchronization application resident on a host computer to keep the information stored in the non-volatile storage area 968 synchronized with corresponding information stored at the host computer. As should be appreciated, other applications may be loaded into the memory 962 and run on the mobile computing device 900.

According to an aspect, the system 902 has a power supply 970, which is implemented as one or more batteries. According to an aspect, the power supply 970 further includes an external power source, such as an AC adapter or a powered docking cradle that supplements or recharges the batteries.

According to an aspect, the system 902 includes a radio 972 that performs the function of transmitting and receiving radio frequency communications. The radio 972 facilitates wireless connectivity between the system 902 and the “outside world,” via a communications carrier or service provider. Transmissions to and from the radio 972 are conducted under control of the operating system 964. In other words, communications received by the radio 972 may be disseminated to the application programs 950 via the operating system 964, and vice versa.

According to an aspect, the visual indicator 920 is used to provide visual notifications and/or an audio interface 974 is used for producing audible notifications via the audio transducer 925. In the illustrated example, the visual indicator 920 is a light emitting diode (LED) and the audio transducer 925 is a speaker. These devices may be directly coupled to the power supply 970 so that when activated, they remain on for a duration dictated by the notification mechanism even though the processor 960 and other components might shut down for conserving battery power. The LED may be programmed to remain on indefinitely until the user takes action to indicate the powered-on status of the device. The audio interface 974 is used to provide audible signals to and receive audible signals from the user. For example, in addition to being coupled to the audio transducer 925, the audio interface 974 may also be coupled to a microphone to receive audible input, such as to facilitate a telephone conversation. According to an aspect, the system 902 further includes a video interface 976 that enables an operation of an on-board camera 930 to record still images, video stream, and the like.

According to an aspect, a mobile computing device 900 implementing the system 902 has additional features or functionality. For example, the mobile computing device 900 includes additional data storage devices (removable and/or non-removable) such as, magnetic disks, optical disks, or tape. Such additional storage is illustrated in FIG. 9B by the non-volatile storage area 968.

According to an aspect, data/information generated or captured by the mobile computing device 900 and stored via the system 902 is stored locally on the mobile computing device 900, as described above. According to another aspect, the data is stored on any number of storage media that is accessible by the device via the radio 972 or via a wired connection between the mobile computing device 900 and a separate computing device associated with the mobile computing device 900, for example, a server computer in a distributed computing network, such as the Internet. As should be appreciated such data/information is accessible via the mobile computing device 900 via the radio 972 or via a distributed computing network. Similarly, according to an aspect, such data/information is readily transferred between computing devices for storage and use according to well-known data/information transfer and storage means, including electronic mail and collaborative data/information sharing systems.

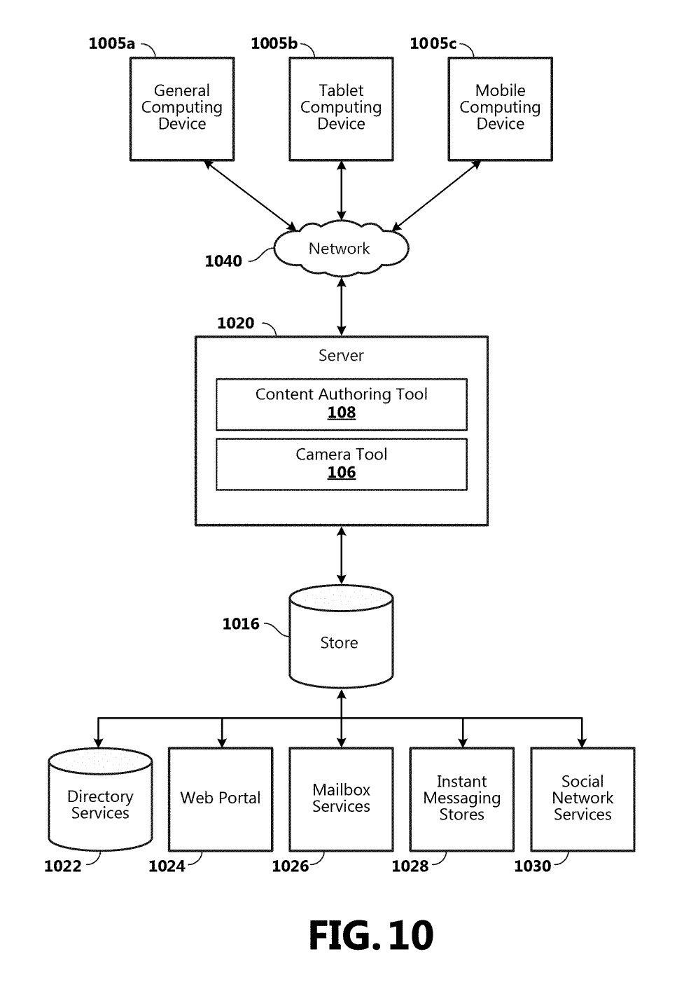

FIG. 10 illustrates one example of the architecture of a system for providing an inline insertion viewport 112 as described above. Content developed, interacted with, or edited in association with the content authoring tool 108 and camera tool 106 is enabled to be stored in different communication channels or other storage types. For example, various documents may be stored using a directory service 1022, a web portal 1024, a mailbox service 1026, an instant messaging store 1028, or a social networking site 1030. The content authoring tool 108 and camera tool 106 are operative to use any of these types of systems or the like for providing an inline insertion viewport 112, as described herein. According to an aspect, a server 1020 provides the content authoring tool 108 and camera tool 106 to clients 1005a,b,c. As one example, the server 1020 is a web server providing the content authoring tool 108 and camera tool 106 over the web. The server 1020 provides the content authoring tool 108 and camera tool 106 over the web to clients 1005 through a network 1040. By way of example, the client computing device is implemented and embodied in a personal computer 1005a, a tablet computing device 1005b or a mobile computing device 1005c (e.g., a smart phone), or other computing device. Any of these examples of the client computing device are operable to obtain content from the store 1016.

Implementations, for example, are described above with reference to block diagrams and/or operational illustrations of methods, systems, and computer program products according to aspects. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

The description and illustration of one or more examples provided in this application are not intended to limit or restrict the scope as claimed in any way. The aspects, examples, and details provided in this application are considered sufficient to convey possession and enable others to make and use the best mode. Implementations should not be construed as being limited to any aspect, example, or detail provided in this application. Regardless of whether shown and described in combination or separately, the various features (both structural and methodological) are intended to be selectively included or omitted to produce an example with a particular set of features. Having been provided with the description and illustration of the present application, one skilled in the art may envision variations, modifications, and alternate examples falling within the spirit of the broader aspects of the general inventive concept embodied in this application that do not depart from the broader scope.

We claim:

1. A computer-implemented method for providing an inline insertion viewport, comprising:
displaying a content authoring canvas of an application;
receiving a selection of a functionality, wherein the functionality is associated with inserting a content element at an insertion point in the content authoring canvas;
activating the selected functionality; and
displaying, at the insertion point, the inline insertion viewport, wherein the inline insertion viewport is associated with the selected functionality and provides a preview of the content element within context of the content authoring canvas.

2. The method of claim 1, wherein receiving the selection of the functionality comprises receiving a selection of a camera functionality, wherein the camera functionality comprises capturing a photo for insertion in the content authoring canvas.

3. The method of claim 2, wherein activating the selected functionality comprises activating a camera tool.

4. The method of claim 3, wherein displaying the inline insertion viewport comprises displaying an image seen through the lens of the camera tool in the insertion viewport.

5. The method of claim 4, further comprising:
providing a functionality command, which when selected, activates a shutter of the camera tool for capturing the image;
responsive to receiving a selection of the functionality command, inserting the captured image in the content authoring canvas at the insertion point; and
removing the inline insertion viewport from the content authoring canvas.

6. The method of claim 5, wherein prior to receiving the selection of the functionality command:
updating a location of the insertion point and the inline insertion viewport in the content authoring canvas responsive to a user-movement of the inline insertion viewport to the location; and
adjusting content in the content authoring canvas based on the updated location of the inline insertion viewport.

7. The method of claim 1, wherein receiving the selection of the functionality comprises receiving a selection of one of:
a previously-captured or stored photo insertion functionality; and
a previously-captured or stored video insertion functionality.

8. The method of claim 7, wherein displaying the inline insertion viewport comprises displaying a preview image of one of:
a previously-captured or stored photo; and
a previously-captured or stored video.

9. The method of claim 8, further comprising:
displaying a functionality command for selectively inserting the content element associated with the preview in the content authoring canvas;
responsive to receiving a selection of the functionality command, inserting the content element in the content authoring canvas at the insertion point; and
removing the inline insertion viewport from the display.

10. The method of 9, further comprising:
displaying one or more functionality controls for navigating through previews of content elements; and
responsive to a selection of one of the one or more functionality controls for navigating through previews of content elements, displaying a next or previous content element in the inline insertion viewport.

11. A system for providing an inline insertion viewport, the system comprising a computing device, the computing device comprising:
at least one processing device; and
at least one computer readable data storage device storing instructions that, when executed by the at least one processing device, enable the computing device to:
display a content authoring canvas of an application;
receive a selection of a functionality, wherein the functionality is associated with inserting a content element at an insertion point in the content authoring canvas;
activate the selected functionality; and
display, at the insertion point, the inline insertion viewport, wherein the inline insertion viewport is associated with the selected functionality and provides a preview of the content element within context of the content authoring canvas.

12. The system of claim 11, wherein the system is further operative to:
display a functionality command for selectively inserting the content element associated with the preview in the content authoring canvas;
responsive to receiving a selection of the functionality command, insert the content element in the content authoring canvas at the insertion point; and
remove the inline insertion viewport from the display.

13. The system of claim 12, wherein the functionality associated with inserting the content element at an insertion point in the content authoring canvas is a camera functionality, wherein the camera functionality comprises capturing a photo for insertion in the content authoring canvas.

14. The system of claim 13, wherein:
in activating the selected functionality, the system is operative to activate a camera tool; and
in displaying the inline insertion viewport, the system is operative to display an image seen through the lens of the camera tool in the insertion viewport.

15. The system of claim 13, wherein in displaying the functionality command for selectively inserting the content element associated with the preview in the content authoring canvas, the system is operative to:
provide a functionality command, which when selected, activates a shutter of the camera tool for capturing the image; and
responsive to receiving a user selection of the functionality command, inserting the captured image in the content authoring canvas at the insertion point.

16. The system of claim 15, wherein prior to receiving the user selection of the functionality command, the system is further operative to:
update a location of the insertion point and the inline insertion viewport in the content authoring canvas responsive to a user-movement of the inline insertion viewport to the location; and
adjust content in the content authoring canvas based on the updated location of the inline insertion viewport.

17. The system of claim 12, wherein the functionality associated with inserting the content element at an insertion point in the content authoring canvas is one of:
a previously-captured or stored photo insertion functionality; and
a previously-captured or stored video insertion functionality.

18. The system of claim 17, wherein in displaying the inline insertion viewport, the system is operative to display a preview image of one of:
a previously-captured or stored photo; and
a previously-captured or stored video.

19. The system of claim 18, wherein the system is further operative to:
display one or more functionality controls for navigating through previews of previously-captured or stored photos or videos; and
responsive to a user selection of one of the one or more functionality controls for navigating through previews of previously-captured or stored photos or videos, display a next or previous previously-captured or stored photo or video in the inline insertion viewport.

20. A computer readable storage device including computer readable instructions, which when executed by a processing unit is operative to:
display a content authoring canvas of an application;
receive a selection of a camera tool functionality, wherein the camera tool functionality is associated with capturing and inserting a photo at an insertion point in the content authoring canvas;
activate the selected camera tool functionality;
display, at the insertion point, the inline insertion viewport, wherein the inline insertion viewport is associated with the camera tool functionality and provides a preview of an image seen through the lens of the camera tool in the insertion viewport within context of the content authoring canvas;
display a functionality command for activating a shutter of the camera tool functionality for capturing the image;
responsive to receiving a user selection of the functionality command, insert the captured image in the content authoring canvas at the insertion point; and
remove the inline insertion viewport from the display.
